(19) United States
(12) Patent Application Publication
(10) Pub. No.: US 2023/0328547 A1
(43) Pub. Date: Oct. 12, 2023

(54) AUTOMATIC TUNING OF HETEROGENOUS WIRELESS INFRASTRUCTURE

(71) Applicant: Intel Corporation, Santa Clara, CA (US)

(72) Inventors: Mats G. Agerstam, Portland, OR (US); Francesc Guim Bernat, Barcelona (ES); Marcos E. Carranza, Portland, OR (US); Shekar Ramachandran, Bengaluru (IN); Rupali Agrahari, Bengaluru (IN)

(73) Assignee: Intel Corporation, Santa Clara, CA (US)

(21) Appl. No.: 18/209,827

(22) Filed: Jun. 14, 2023

(51) Int. Cl. H04W 24/02; H04W 24/08

(52) U.S. Cl. CPC H04W 24/02; H04W 24/08

(57) ABSTRACT

Embodiments for automatically tuning heterogenous wireless networks are disclosed herein. In one example, performance data is received for multiple wireless networks. The wireless networks are based on multiple wireless technologies, and the performance data is based on multiple layers of the protocol stacks of the wireless technologies. The performance data is used to determine one or more configuration settings to adjust for one or more of the wireless networks. The determined configuration setting(s) are then adjusted.

### BACKGROUND

Deployments of heterogenous wireless infrastructure are emerging at the network edge for a variety of use cases. The growing number and variety of wireless technologies in these deployments present various challenges relating to anomalies and interference, which leads to poor performance. For example, degraded performance can be caused by a variety of factors, such as interference between different radio technologies that are operating on the same or overlapping spectrum and are meant to coexist, inter-technology interference caused by inadequate deployment planning, or unintended or malicious interference caused by external sources. Further, the impact on performance may vary greatly based on the dynamic nature of the environment, such as work schedules or business hours, personnel in the environment, physical obstructions, external agents, and so forth.

### BRIEF DESCRIPTION OF THE DRAWINGS

FIG. 1 illustrates a system for automatically tuning wireless infrastructure.

FIGS. 2A-B illustrate model development and deployment pipelines for supervised and unsupervised learning.

FIG. 3 illustrates a processing pipeline for automatically tuning wireless infrastructure.

FIG. 4 illustrates a processing pipeline for continual learning.

FIG. 5 illustrates a decision tree model for anomaly detection using quality of service metrics.

FIGS. 6A-B illustrate examples of recurrent neural networks.

FIG. 7 illustrates an example of a protocol stack for networking technologies.

FIG. 8 illustrates a flowchart for automatically tuning wireless infrastructure.

FIG. 9 illustrates an overview of an edge cloud configuration for edge computing.

FIG. 10 illustrates operational layers among endpoints, an edge cloud, and cloud computing environments.

FIGS. 11A-B illustrate example embodiments of computing devices and systems.

### EMBODIMENTS OF THE DISCLOSURE

Deployments of heterogenous wireless radio-based technologies are continuously emerging at the network edge for a variety of use cases (e.g., Internet-of-Things (IoT)). The growing number and variety of wireless technologies in these deployments present various challenges relating to anomalies and interference, which leads to poor performance. The root cause of degraded performance in a deployment can include a variety of factors, such as interference between different radio technologies that are operating on the same or overlapping spectrum and are meant to coexist, inter-technology interference caused by inadequate deployment planning, and unintended or malicious interference caused by sources external to equipment in the deployed infrastructure (e.g., weather conditions, neighboring wireless deployments), among other examples. These challenges are exacerbated by the dynamic nature of the environment, as the impact on performance may vary greatly based on changing circumstances, such as work schedules (e.g., business hours, production schedules), personnel in the environment, physical obstructions, external agents, and so forth.

As an example, portable “cellular-in-a-box” deployments are gaining traction as a deployment model for standalone or private cellular networks, but these deployments are very susceptible to signal interference and anomalies. A “cellular-in-a-box” deployment (e.g., 5G-in-a-box) typically includes a portable container or housing that contains all the requisite equipment for deploying a standalone cellular network. In some use cases, this deployment model is used to deploy cellular technology, such as 4G and 5G, in a highly secure manner in environments where public cellular networks do not exist, are down, or provide spotty coverage. This includes disaster recovery and humanitarian actuation situations where there is no known (or trusted) 4G or 5G infrastructure. In these use cases, a “5G-in-a-box” cellular deployment has no knowledge of its deployment environment, including which radio frequencies are already in use, whether other wireless technologies are deployed, and whether any potential sources of interference exist. This can lead to severe connectivity problems in these scenarios. Further, in some cases, a 5G-in-a-box deployment may be moving (e.g., within a vehicle), which substantially increases the likelihood of performance problems as the deployment environment is constantly changing.

Accordingly, this disclosure presents embodiments for automatically tuning heterogenous wireless infrastructure. In some embodiments, a machine-learning-based solution is used to detect and classify sources of interference over a broad spectrum of radio frequencies in a distributed cooperative manner to help provide recommendations and pinpoint sources of error. For example, this solution can detect and pinpoint sources of interference in heterogenous wireless deployments on a manufacturing floor, in a sub-fabrication facility (subfab) of a semiconductor factory, or in an environment with a standalone cellular network (e.g., a “5G-in-a-box” deployment), among other examples.

This solution uses trained artificial intelligence and machine learning (AIL) models to infer such anomalies by analyzing performance data for the wireless technologies cross-sectionally-spanning multiple protocol layers of their respective network stacks-such as:
(i) scans of targeted radio frequency (RF) spectrums and energy;
(ii) signal quality data (e.g., signal strength, signal-to-noise ratio (SNR));
(iii) demodulation errors;
(iv) data transmission errors (e.g., bit error rate (BER) information before and after forward error correction (FEC) schemes, block error rate (BLER), packet error rate (PER), internet protocol (IP) checksum errors); and
(v) traffic performance statistics at the network and transport layers (e.g., packet collisions/drops, retransmission statistics).

For example, the training phase establishes what constitutes normality in the temporal and spatial domains for the respective wireless technologies (e.g., normal performance and behavior based on time and location) using cross-stack performance data from different protocol layers, such as per-technology performance metrics and RF spectrum scans obtained through sensing using a set of distributed nodes in the deployment.

The trained model can then analyze live performance data, along with other sources of input data, to inform of external anomalies that can be sources of interference, as well as technology-specific optimizations (e.g., autocorrection, steering of end devices and user equipment (UE)) to help meet overall objectives with respect to quality of service (QoS) and service-level objective (SLO) requirements for different traffic flows.

This solution provides various advantages. Network planning and troubleshooting for heterogenous wireless infrastructure is a costly and dynamic problem that multiplies with the number of wireless technologies in the infrastructure. This solution provides an autonomous system that recommends and provides feedback regarding tuning and parameters for better and more effective use of radio spectrum, cross-protocol and cross-technology, to meet the requirements of the various traffic flows in the infrastructure. As a result, this solution automates costly network planning and troubleshooting, which provides significant cost savings in terms of operational expenditures (OPEX) and productivity.

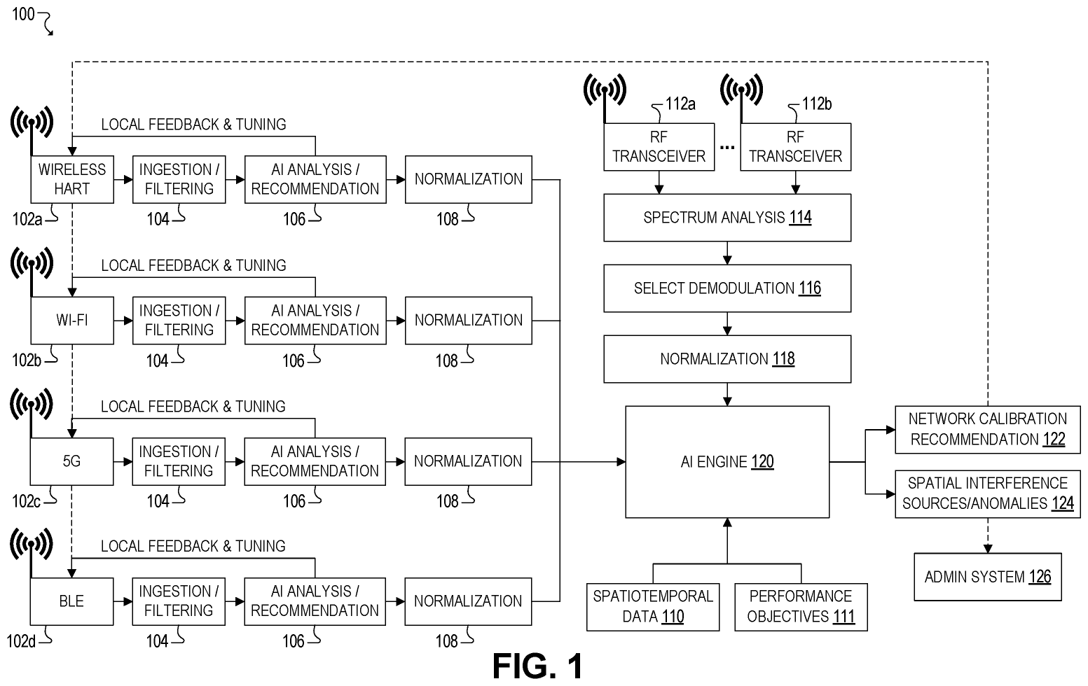

FIG. 1 illustrates an example embodiment of a system 100 for automatically tuning wireless infrastructure. In the illustrated embodiment, the wireless infrastructure includes four wireless networks 102a-d based on various heterogenous wireless technologies, including WirelessHART 102a, Wi-Fi 102b, 5G cellular 102c, and Bluetooth Low Energy (BLE) 102d.

Wireless deployments at the edge are becoming increasingly heterogeneous with respect to the various wireless standards and protocols in the infrastructure, and they are also susceptible to various external sources of potential interference (e.g., personal devices, aspects of the surrounding environment such as physical obstructions or weather), which can negatively impact the overall performance. These technologies are often designed without any concept of coexistence, such as inter-technology coordination to prevent interference and improve performance.

In the illustrated example, system 100 solves the problem from a system-level perspective, taking a cross-protocol view across a multitude of technologies using artificial intelligence and machine learning (AI/ML) models for recommendation, which more effectively addresses several interference and degradation issues.

This solution uses network quality metrics from multiple layers of the wireless protocol stacks, optionally along with external RF transceivers for spectrum sensing, spatial and temporal data, and traffic flow objectives, which are fed as inputs into an AI/ML recommendation engine to aid with the following tasks: (i) per-wireless-technology tuning to reduce interference and attempt to meet the traffic requirements of the pertinent flows; and (ii) spatial pinpointing of interference sources, external or internal to the deployment, which may need the support of an administrator to continue to root cause.

In the illustrated embodiment, multiple wireless networks 102a-d based on heterogenous wireless technologies are deployed in the environment (e.g., WirelessHART, Wi-Fi, 5G, BLE), at least some of which may be operating on the same, adjacent, or overlapping frequency bands.

The system 100 includes a local feedback and tuning pipeline for each wireless network 102a-d, which performs a first level of filtering and analysis of incoming performance data for the corresponding wireless network 102a-d. In the illustrated embodiment, the local feedback and tuning pipeline includes ingestion/filtering 104, AI analysis/recommendation 106, and normalization 108 subsystems.

The ingestion and filtering subsystem 104 collects various quality of service (QoS) metrics across multiple layers of the protocol stack for the corresponding wireless network 102a-d. Examples of the types of metrics that may be collected include, without limitation:
(i) signal quality data (e.g., received signal strength indicator (RSSI), estimated signal-to-noise ratio (SNR));
(ii) general demodulation errors;
(iii) data transmission errors (e.g., bit error rate (BER) before and after applying any forward error correction (FEC) algorithm, block error rate (BLER), packet collisions, packet error rate (PER), checksum errors at the network/transport layers); and
(iv) traffic performance errors and statistics (e.g., jitter, latency, packet drops, packet loss, transmit (TX)/receive (RX) statistics, retransmission statistics, congestion window size, sliding window size).

In general, these QoS metrics may span all the relevant layers of the protocol stack of a particular wireless technology, including the physical layer or layer one (L1) (e.g., signal quality data such as RSSI/SNR, demodulation error metrics), data link layer (e.g., error detection/correction metrics, packet collisions), network layer (e.g., internet protocol (IP) checksum errors, packet drops), and transport layer (e.g., transmission control protocol (TCP)/user datagram protocol (UDP) checksum errors, packet loss, retransmission statistics, congestion window size).

However, the specific QoS metrics collected for each wireless network 102a-d may vary for different wireless technologies (e.g., based on how the technology works, the availability of certain metrics and counters, etc.). In particular, some metrics may be unique to specific wireless technologies, while other metrics may be common to some or all of the wireless technologies. As an example, block error rate (BLER)—which is defined as the ratio of erroneously transmitted blocks to total transmitted blocks—is unique to 3GPP cellular technology. By contrast, metrics for commonly-used network and transport layer protocols such as IP, TCP, and UDP—may be common to any wireless technologies that use those protocols.

The QoS metrics are fed into the local AI analysis and recommendation subsystem 106, which analyzes the metrics and generates local feedback and tuning recommendations for the corresponding wireless network 102a-d. These tuning recommendations are designed to reconfigure/recalibrate how the applicable wireless network 102a-d should operate in order to increase performance. Thus, the tuning recommendations may optionally be fed directly back into the associated wireless infrastructure to recalibrate the corresponding wireless network 102a-d.

Examples of local feedback and tuning recommendations include, without limitation, adjustments to any of the following parameters or settings:
(i) modulation settings;
(ii) transmission power settings (e.g., TX power adjustments);
(iii) operating channel settings (e.g., switching to an alternative operating channel); (iv) radio resource management (RRM) settings; and
(v) QoS control settings (e.g., queuing policies and prioritization of different traffic flows, traffic steering, bandwidth allocation, technology-specific QoS controls).

The specific tuning recommendations for each wireless network 102a-d may vary for different wireless technologies (e.g., based on how the technology works, the availability of certain parameters, settings, or features). In particular, some tuning parameters may be unique to specific wireless technologies, while other tuning parameters may be common to some or all of the wireless technologies.

As an example, the tuning recommendations for Wi-Fi may recommend changing the operating channel to avoid interference, which is not possible for Bluetooth Low Energy (BLE), as BLE uses a well-defined frequency hoping scheme determined based on connection time.

As another example, the tuning recommendations for Wi-Fi and cellular technology (e.g., 4G/5G) may recommend selecting a different modulation and coding scheme (MCS) index to indirectly change the modulation scheme, coding scheme, and/or related parameters, such as bandwidth, guard interval (e.g., the amount of time between successive symbols), number of spatial streams (e.g., multiple-input multiple-output (MIMO)), and coding range (e.g., how much FEC is applied for purposes of being able to detect and correct bit errors).

After performing the first level of filtering and analysis on a per-wireless-network basis, the QoS metrics collected for each wireless network 102a-d are normalized by the normalization subsystem 108 in the local pipeline of each wireless network 102a-d.

The normalized metrics for all wireless networks 102a-d are then fed into an AI analysis engine 120, optionally along with other sources of information, such as RF spectrum data, spatiotemporal data, and performance objectives.

The RF spectrum data provides information about the RF spectrum currently in use in the environment, such as frequency bands or channels in use and their associated power/energy levels. In some embodiments, for example, external RF transceivers 112a-b (e.g., independent of the wireless infrastructure 102a-d) may be deployed throughout the environment or coverage area of the wireless infrastructure. These RF transceivers 112a-b perform spectrum sensing to detect RF activity in the environment (e.g., by measuring the magnitude and frequency of detected RF signals), and the RF activity is then analyzed by a spectrum analysis subsystem 114 to detect potential sources of interference, which may assist in moving certain wireless networks 102a-d to alternative channels. Further, in some embodiments, a demodulation subsystem 116 may perform layer 1 (L1) demodulation of select RF signals for known wireless technologies (e.g., signals associated with the known wireless networks 102a-d) to extract more detailed information about the modulated signals, which enables more effective tuning recommendations to be provided. The RF spectrum data and/or demodulation data may then be normalized by a normalization subsystem 118 and fed into the AI engine 120.

The spatiotemporal data 110 includes spatial and/or temporal data indicating how the performance of the wireless networks 102a-d may vary based on time and location. For example, network performance and interference conditions may vary over time and space across the coverage area of the wireless infrastructure based on a variety of factors, including, without limitation, network layout (e.g., the location, resource capacity, and coverage area of, and relative distances between, nodes in the wireless infrastructure, such as base stations or access points), network load (e.g., volume of traffic, number/density/location of UEs and other connected devices), schedules (e.g., time of day, day of week, weekday vs. weekend, holidays, business hours, production schedules, rush hour and other vehicular traffic), events (e.g., sporting events, concerts), personnel in the environment, physical obstructions, weather conditions (e.g., conditions such as fog, clouds, rain, and lightning may reduce signal strength and/or cause signal interference), external agents, and so forth. Accordingly, the spatiotemporal data 110 provides information about the various factors that may impact the performance of some or all of the wireless networks 102a-d at certain times and/or locations, such as the network layout, historical network load information, UE/device locations from a location service, weather conditions from a weather service, vehicular traffic patterns from a navigation service, geographical topography from a mapping service, calendar/scheduling information regarding work/personal days (e.g., day of week, weekday vs. weekend, holidays), business hours, business schedules, events, and so forth.

As an example, the network nodes associated with the wireless networks 102a-d (e.g., access points, base stations), and the endpoint devices connected to them, are in different locations throughout the environment covered by the wireless infrastructure. Based on the respective locations of the network nodes and endpoint devices, some locations in the environment may be more susceptible to interference and/or poor signal quality than others. As a result, knowing the locations of network nodes and endpoint devices, and the relative distances between them, can aid in generating tuning recommendations to improve overall performance. Thus, in some cases, this information may be included in the spatiotemporal data 110.

As another example, there may be outside factors present and active in the environment during certain times for which adaptation needs to happen, such as numerous endpoint devices in dense areas (e.g., cell phones or other wireless devices of workers during business hours or crowds of people at events/attractions), poor weather conditions that impact signal quality, and so forth. In a manufacturing scenario, for example, different processes may be active at different times based on schedules which may activate different wireless end devices. In some cases, this type of enterprise scheduling information could be supplied by fleet and site planning management systems. Similar types of scheduling information could be provided for wireless infrastructure deployed in crowded areas, such as sporting arenas, event venues, shopping malls, and so forth. Thus, in some cases, this type of scheduling information may be included in the spatiotemporal data 110.

The performance objectives 111 provide guidance on how to tune the wireless infrastructure against an overall objective function for all wireless networks 102a-d and associated wireless technologies. In some embodiments, for example, the performance objectives 111 may include traffic flow objectives that prioritize the various traffic flows across all wireless networks 102a-d.

In some cases, for example, certain wireless networks 102a-d, wireless technologies, and/or traffic flows may be higher priority or more important than others from a quality of service perspective. As an example, WirelessHART 102a may be more critical than Wi-Fi 102b and may be driven by a static or dynamic schedule. As a result, any such prioritization should be taken into consideration when generating tuning recommendations for the wireless networks 102a-d. In some cases, for example, the holistic priorities across the wireless networks 102a-d in the deployment may impact physical or datalink layer settings for certain networks 102a-d, such as modulation settings or transmit power (e.g., increasing the transmission power of wireless networks 102a-d that are high priority or have high-priority traffic flows). Thus, in some cases, these priorities may be specified as performance objectives 111, which are considered when generating tuning recommendations across the wireless networks 102a-d.

These various sources of input data-such as QoS metrics, RF spectrum and demodulation data, spatiotemporal data, and performance objectives—are referred to throughout this disclosure as “performance data.” This performance data is fed into the AI engine 120, which is trained to output per-technology recommendations and tuning of parameters. In some embodiments, for example, based on the performance data, the AI engine 120 outputs network calibration and tuning recommendations 122 for each wireless network 102a-d, along with an identification of any sources of spatial interference or other anomalies 124.

The types of tuning recommendations 122 output by the AI engine 120 may be similar to those identified above with respect the local AI analysis/recommendation engines 106 for the individual wireless networks 102a-d. However, the tuning recommendations 122 output by the AI engine 120 may seek to balance the holistic priorities across all wireless networks 102a-d and wireless technologies in the deployment rather than simply increasing the performance of each wireless network 102a-d in isolation.

For example, based on the respective priorities across the networks 102a-d, the tuning recommendations 122 may define traffic classes that provide a higher degree of quality of service for certain traffic flows, wireless networks 102a-d, and/or wireless technologies, which may require adjustments to certain settings relating to technology-specific QoS controls. Examples of such QoS controls include, without limitation, the 5G Network Exposure Function (NEF) to deliver quality of service to specific devices/streams, Wi-Fi 6+ QoS support, and QoS controls at the converged IPv6/IPv4 layer (e.g., through the differentiated services code point (DSCP) field in the IP header, bandwidth allocation, and queueing policies and priorities).

Further, the tuning recommendations 122 may be fed back to the wireless infrastructure to recalibrate or reconfigure the applicable wireless networks 102a-d. In some cases, the tuning recommendations may fully or partially address any sources of interference or anomalies 124 that are identified. Alternatively, or additionally, the sources of interference or anomalies 124 may be provided to an administration system 126 to enable a system administrator to perform further troubleshooting, identify the root cause, and/or implement a solution.

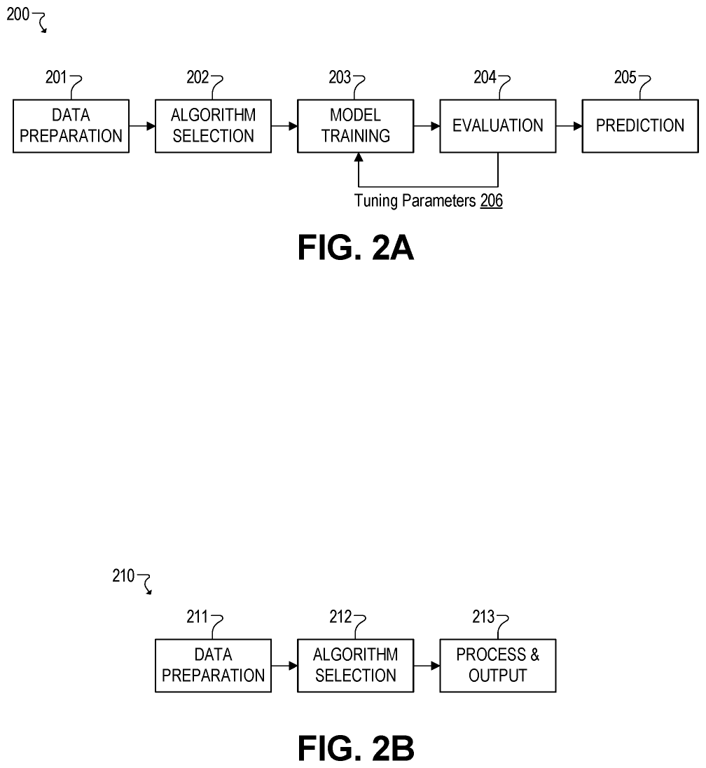

In various embodiments, the AI engines 106, 120 may use any type and/or combination of artificial intelligence and/or machine learning techniques to generate tuning recommendations and identify potential sources of interference or anomalies, including, without limitation, decision tree learning (e.g., decision trees, random forest, classification and regression trees (CART)), gradient boosting (e.g., extreme gradient boosted trees), clustering (e.g., k-nearest neighbors (kNN), Gaussian mixture models (gMM), k-means clustering), Bayesian networks, Naïve-Bayes, support vector machines (SVM), artificial neural networks (ANN), feed-forward artificial neural networks, deep learning, deep neural networks, recurrent neural networks (RNN) (e.g., long short-term memory (LSTM) networks), transformers, convolutional neural networks (CNNs), moving average models, autoregressive moving average (ARMA) models, autoregressive integrated moving average (ARIMA) models, exponential smoothing models, regression analysis models (e.g., logistic regression), and/or ensembles thereof (e.g., models that combine the predictions of multiple machine learning models to improve prediction accuracy), among other examples. Examples of various types of AI/ML that may be used to implement the AI engines 106, 120 are described further in connection with FIGS. 2-6.

Artificial intelligence (AI) has become a vital enabler of the digital transformation journey for service providers in the telecommunication industry, providing them with the insights and capabilities they need to be more agile and take a more software-centric approach to their role.

As a subset of AI, machine learning (ML) is a powerful tool that can be used for network anomaly detection via scientific study of traffic samples (this procedure varies for different types or categories of ML). The capability of ML to make decisions after study and analysis relieves people from manually processing massive volumes of data. Further, ML is typically able to respond to abnormal behavior much faster than humans, which is advantageous for early detection. ML can create diverse models with various algorithms, but the way these models are developed and trained also has a big impact on model performance.

Even if running the same model to detect the same type of attack, the outcome may vary depending on the features the model is trained to consider. In fact, in many cases, the most difficult step of ML model development is data preparation, as the output of an ML model relies heavily on the data from which the algorithms learn to distinguish normal operations from anomalous behaviors.

This disclosure presents various ML algorithms that may be used to implement ML models for anomaly detection in different network contexts. In general, most types of machine learning can be categorized as supervised learning or unsupervised learning. The typical model development and deployment processes for supervised and unsupervised learning are shown in FIGS. 2A and 2B, respectively.

For example, FIG. 2A shows a model development and deployment pipeline 200 for supervised learning. A supervised learning model learns from past experience (e.g., represented by labeled training data) and uses that learning as a reference to make decisions on unknown (e.g., unlabeled) data in the future. A labeled dataset is used to train the model and then the model is validated using validation data to tune any hyperparameters. Supervised learning techniques are generally used for classification and regression problems, such as spam classification and weather forecasting.

In the illustrated example, the supervised learning pipeline 200 includes data preparation 201 (e.g., preparing the training dataset, including feature selection, collecting data samples, and preprocessing/filtering the data samples), algorithm selection 202 (e.g., selecting the appropriate supervised learning algorithm(s) for the particular use case), model training 203 (e.g., training a model using the selected ML algorithm(s) and the training dataset), model evaluation 204 (e.g., evaluating the model performance using validation or test data and tuning any hyperparameters 206 to improve performance), and prediction/inference 205 (e.g., using the trained model to render predictions or inferences based on unlabeled or live data).

FIG. 2B shows a model development and deployment pipeline 210 for unsupervised learning. An unsupervised learning model tries to learn from unlabeled data by finding hidden structure and patterns in the data samples to group them. This approach can be used for clustering or feature selection to identify correlated features in the dataset.

In the illustrated example, the unsupervised learning pipeline 210 includes data preparation 211 (e.g., feature selection, preparing unlabeled data samples), algorithm selection 212 (e.g., selecting the appropriate unsupervised learning algorithm(s) for the particular use case), and process and output 213 (e.g., using the model to render predictions or inferences by identifying patterns, correlated features, and/or groupings of the unlabeled data samples).

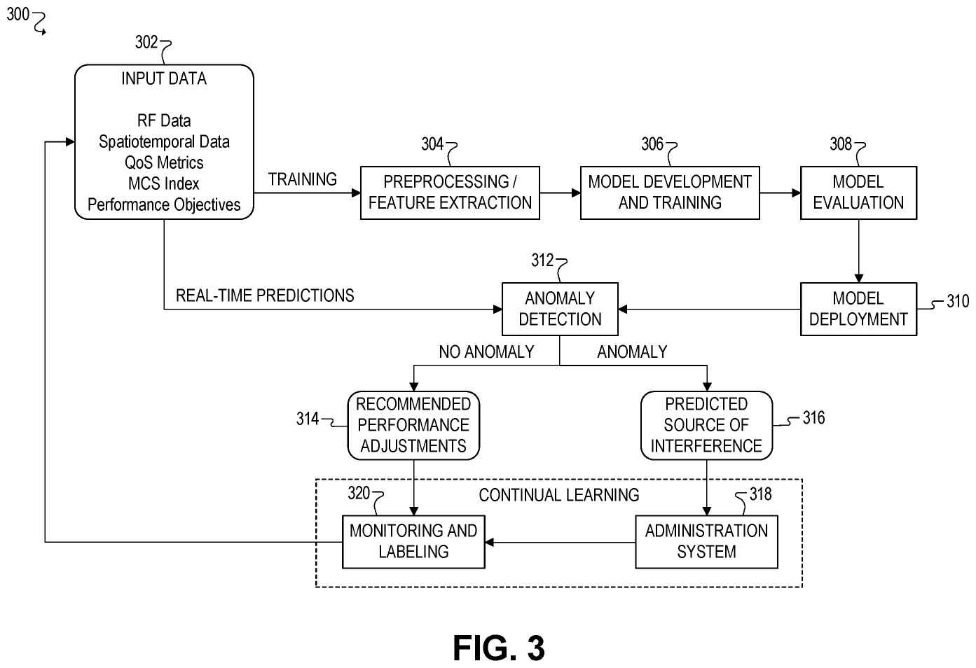

FIG. 3 illustrates a processing pipeline 300 for automatically tuning wireless infrastructure. In some embodiments, for example, processing pipeline 300 may be used to automatically tune a wireless infrastructure having multiple wireless networks based on heterogenous wireless technologies.

In the illustrated embodiment, the processing pipeline 300 receives various types of input or performance data 302 from different sources, such as quality of service (QoS) metrics for wireless networks deployed in the infrastructure (e.g., performance metrics spanning multiple layers of the protocol stacks of the respective wireless technologies used by the wireless networks), radio frequency (RF) data (e.g., frequency bands in the RF spectrum currently in use and/or their associated energy levels), spatiotemporal data (e.g., contextual information relevant to the performance of certain wireless network(s) based on time and location), modulation and coding scheme (MCS) indices for various wireless technologies (e.g., MCS indices for Wi-Fi, cellular), and performance objectives (e.g., traffic flow objectives).

The input data 302 is initially collected for training purposes (e.g., training AI/ML model(s) to detect anomalies and/or provide tuning recommendations for wireless networks in the infrastructure). However, the same type of input data 302 is subsequently used for inference purposes (e.g., using the trained model(s) to detect anomalies and/or provide tuning recommendations based on live or real-time input data 302).

With respect to the training pipeline, a preprocessing/feature extraction task 304 is performed to preprocess the input data 302 (also referred to as training data 302 in this context) and extract the appropriate features that will be used to train the model. For example, the collected input data 302 may not be suitable to train the model in its current form. As a result, various types of preprocessing may be performed, such as data de-duplication, data balancing, normalization, adding timestamps, and so forth.

For example, duplicative data samples may be removed from the input data 302 so the trained model is not biased, and data may be balanced across all output classes (e.g., anomaly, non-anomaly).

The respective features in the input data 302 may be normalized by converting them into a format that can be understood by the model. For example, since machine learning models generally require inputs to be represented in numeric format, any features with values represented in string format must be converted into numeric representations.

Further, a timestamp may be added as a feature to each data sample in the input data 302. For example, with respect to network-related anomaly detection, any scenario that is a true positive during the day might be a false positive at night. As a result, time may be included as one of the features used to train the model to reduce false positives and improve overall accuracy.

Moreover, the data samples in the input data 302 should only include features that are important for purposes of training the model (e.g., features that are highly correlated with the predictions/inferences that the model will be trained to make). Thus, the important features may be extracted from the input data 302 and the remaining unimportant features may be discarded. In some embodiments, unsupervised learning may be used to identify the correlated attributes for feature selection. For example, if two attributes are highly correlated with each other, then they are linearly dependent on each other, so either one of these attributes can be selected as a feature and the other can be dropped.

Next, a model development and training task 306 is performed to train the model using the prepared training data 302 and the appropriate ML algorithm(s). In some embodiments, since the input data 302 may include a variety of features with different ranges of numbers and different sizes, multiple models may be trained using different types of ML algorithms and different subsets of the input data 302.

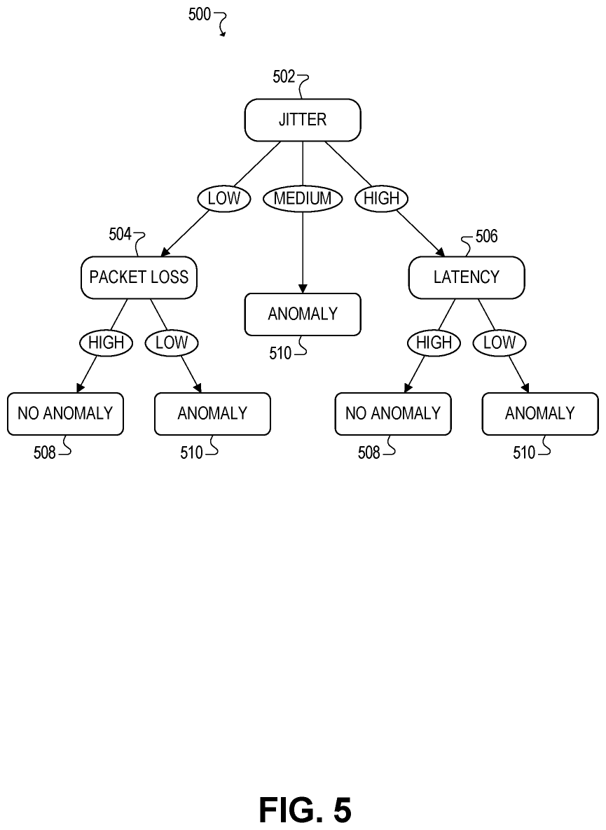

For example, the quality of service (QoS) metrics contain discrete performance metrics (e.g., signal strength, signal-to-noise ratio, packet loss, jitter, latency, etc.), each of which can be treated as a single feature. Thus, in some embodiments, a decision tree algorithm may be used to train a model based on the QoS metrics (e.g., as described below in connection with FIG. 5).

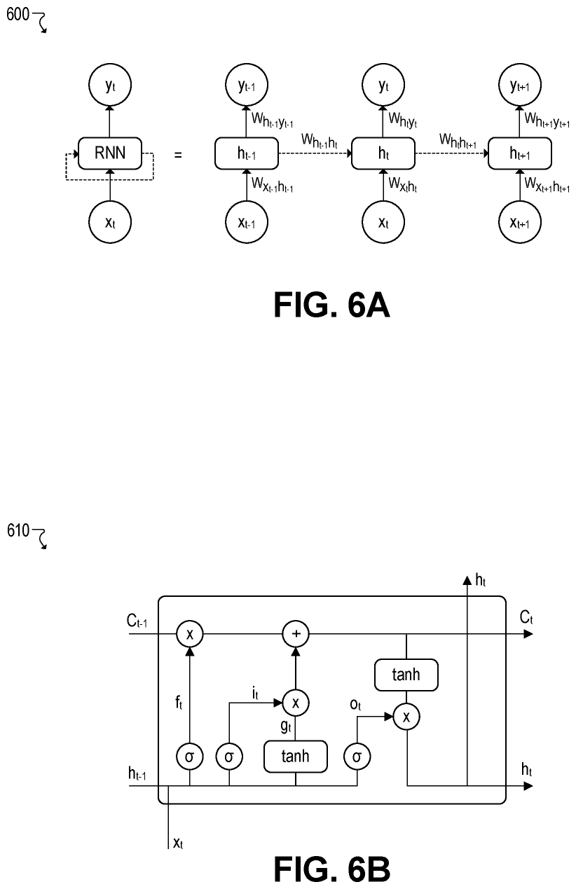

By contrast, with respect to the radio frequency (RF) data, RF data captured over some period of time may be used to train a model. For this type of time-series data, a recurrent neural network (RNN) supervised learning model may be used, such as a long short-term memory (LSTM) network (e.g., as described below in connection with FIGS. 6A-B).

Next, a model evaluation task 308 is performed to validate and test the model. Validation is performed using a validation dataset, which contains data samples that were held back during training. For example, the validation dataset may contain the same type of data as the training dataset 302, but the validation dataset may only include data samples that were omitted from the training dataset 302 and were not used to train the model. The validation dataset is used to evaluate the performance of the model while also tuning its hyperparameters to increase performance. For example, based on the accuracy of the model's predictions when processing the validation dataset, certain hyperparameters of the model may be tuned and the model may be retrained using the updated parameters.

Testing is performed on the fully-trained model using a test dataset, which contains data samples that were held back during training and validation and thus are completely new and unknown to the model. The test dataset is used to determine an unbiased estimate of the performance of the final model.

Next, a model deployment task 310 is performed to deploy the model for rendering real-time predictions or inferences using live input data 302.

Once the model is deployed, an anomaly detection task 312 is performed to detect anomalies 316 and/or recommend performance adjustments 314. For example, the anomaly detection task 312 uses the trained model to render real-time predictions and inferences regarding the source of potential anomalies/interference 316 and recommended performance adjustments 314 based on live input data 302 (e.g., unlabeled/unseen input data captured in real time).

In the illustrated embodiment, if no anomaly is detected, the anomaly detection task 312 may recommend performance adjustments 314 for one or more of the wireless networks to improve performance (e.g., suggestions for correct network calibration, adjustments to configuration settings).

If an anomaly is detected, the anomaly detection task 312 may identify the predicted source of spatial interference 316 that is causing the anomaly. The predicted source of interference 316 may then be reported to a human-monitored administration system 318 to aid in troubleshooting the anomaly.

It is also beneficial for the model to continue learning to remain up to date and understand the latest behavior of traffic. For example, in real time, the model may face new types/patterns of data that it is unaware of and did not see during training, as the model cannot realistically be trained with every possible dataset and scenario the first time around. As a result, the model should preferably be capable of learning from new data and new scenarios that it faces during real-time predictions to remain up to date on the latest network behavior and patterns.

Thus, in some embodiments, continual learning techniques may be applied to ensure the model remains up to date. For example, the model parameters can be recomputed for any new input data that the model receives when rendering real-time predictions. In this manner, when the model receives new data different from the data it was trained on, the model can learn from that data to make better decisions in the future when it encounters similar data.

In the illustrated example, the input data 302, tuning recommendations 314, and identified sources of interference/anomalies 316 are used for continual learning. For example, with assistance from the human-monitored administration system 318, a monitoring and labeling task 320 is performed to (i) monitor the live input data 302 and the corresponding predictions 314, 316 generated by the model and (ii) label that input data 302 with ground truth values (e.g., anomaly or non-anomaly, performance adjustments) to retrain/update the model for continual learning purposes. The newly-labeled input data 302 is then added to the original training data 302 and the training portion of the pipeline 300 (e.g., 302-310) is repeated to retrain the model using the updated training data 302.

There are various approaches to continual learning that could be applied, such as brute force updates, scheduled updates, event-driven updates, and online updates.

Brute force updates, which provide the simplest solution, simply recompute the model parameters on the most recent data window every time a new data point arrives. In some cases, however, this approach may be infeasible if fitting the model to the window is too computationally complex.

With scheduled updates, the model parameters are cached for a given period of time (e.g., 24 hours), and the model is retrained on the new data points at the end of each period.

However, excessive false positive alerts can occur if the behavior of the metrics changes before each scheduled update.

With event-driven updates, the model parameters are recomputed when a high prediction error is detected for the most recent set of data points. The timing of event-driven updates can be unpredictable, however, which can lead to operational challenges in the future.

With online updates, some machine learning algorithms can be reformulated to work in an online setting, continuously reading in new data points and efficiently updating the parameters with each data point.

While any of these approaches can be used, brute force updates and online updates may be the most suitable for this use case due to the downsides of scheduled updates and event-driven updates.

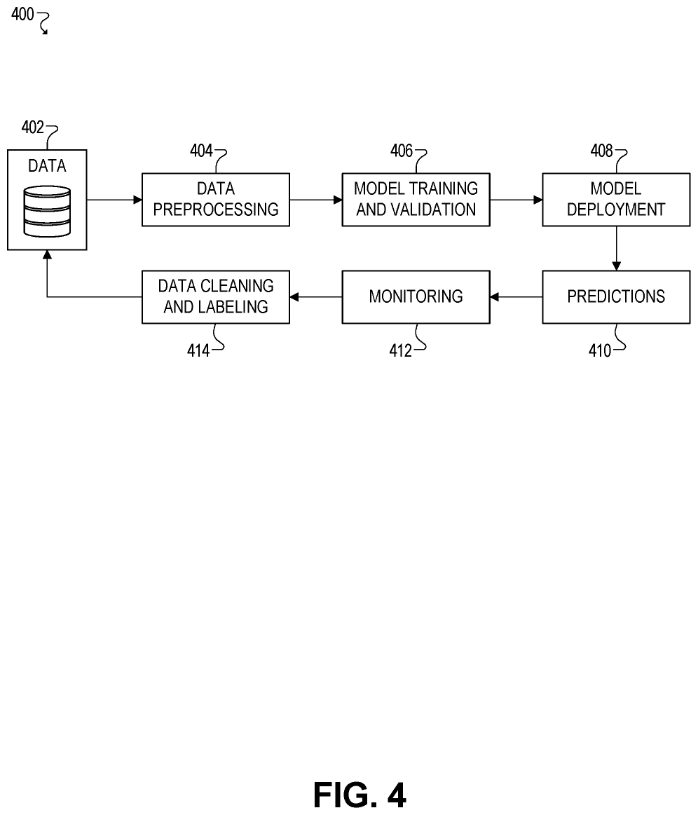

FIG. 4 illustrates a processing pipeline 400 for continual learning. In the illustrated example, the continual learning pipeline 400 includes data preprocessing 404 (e.g., preprocessing the training data 402), model training and validation 406 (e.g., training a model using the training data 602 and the appropriate ML algorithm(s)), model deployment 408, predictions/inference 410 (e.g., using the trained/deployed model to render predictions/inferences based on unlabeled/live data), monitoring 412 (e.g., monitoring the input data samples and predictions generated by the model), and data cleaning and labeling 414 (e.g., cleaning/labeling new data samples to retrain/update the model). The newly cleaned and labeled data is then added to the training data 402 and the pipeline 400 is repeated to retrain the model using the updated training data 402.

FIG. 5 illustrates an example of a decision tree model 500 for anomaly detection using quality of service (QoS) metrics. In some embodiments, for example, decision tree model 500 may be trained using the process flow 300 of FIG. 3 using QoS metrics, as described below.

First, the QoS metrics are split into three datasets: a training dataset, a validation dataset, and a testing dataset.

The decision tree 500 is initially trained using the training dataset. During the training process, the entire training dataset is initially considered at the root node. On each iteration of the algorithm, the entropy (H) and information gain (IG) will be computed for each attribute.

Entropy is a measure of the randomness in the information being processed. The higher the entropy, the harder it is to draw any conclusions from that information. Entropy can be computed using the following equation:

$$E ( S ) = {\sum }_{i = 1}^{c} - {p}_{i} {log}_{2} {p}_{i}$$

where S is the current state, and pᵢ is the probability of an event i of state S or percentage of class i in a node of state S.

Information gain (IG) is the decrease in entropy. IG is a statistical property that measures how well a given attribute separates the training samples according to their target classification. IG can be computed using the following equation:

$$I G = Entropy ( before ) - {\sum }_{j = 1}^{k} Entropy ( j , after )$$

where “before” is the dataset before the split, k is the number of subsets generated by the split, and (j, after) is subset j after the split.

The attribute with the smallest entropy or largest information gain is selected as the next node, which divides the set of data of its parent node into two or more subsets.

The process continues in this manner, where each iteration only considers the remaining attributes that were not selected in prior iterations, until stopping criteria is met. In the final tree, the number of leaf nodes is equal to the number of output classes, and each leaf node contains the subset of training data corresponding to its respective output class.

In the illustrated example, the QoS metrics used to train the decision tree 500 for anomaly detection include bandwidth, jitter, packet loss, and latency, as shown in Table 1. In particular, each row of Table 1 represents a data sample in the training dataset, and each data sample has values for the bandwidth, jitter, packet loss, and latency metrics, along with a ground truth value indicating whether there is an anomaly.

TABLE 1:
QoS metric dataset for decision tree model training

| BANDWIDTH | JITTER | PACKET LOSS | LATENCY | ANOMALY |
|---|---|---|---|---|
| Low | Low | High | Low | No |
| Low | Medium | High | Low | Yes |
| Medium | Low | Low | High | Yes |
| Medium | Medium | High | High | Yes |
| Medium | High | High | High | No |
| High | High | Low | High | No |
| Medium | High | High | Low | Yes |
| Low | Low | High | High | No |
| Low | Medium | Low | Low | Yes |
| medium | High | high | High | No |

Based on the data samples in Table 1, the information gain of jitter is higher than other attributes, thus jitter is chosen as the root node. Similarly for each value of jitter, information gain is calculated for the remaining attributes using the process described above, until the stopping criteria is met. The decision tree 500 is then validated and tested using the validation and testing datasets.

The resulting decision tree 500 is shown in FIG. 5. At the root node 502, jitter is evaluated.

If jitter is low at node 502, the tree branches to node 504, where packet loss is evaluated. If packet loss is high at node 504, the tree branches to leaf node 508, where no anomaly is detected. If packet loss is low at node 504, the tree branches to leaf node 510, where an anomaly is detected.

If jitter is medium at node 502, the tree branches to leaf node 510, where an anomaly is detected.

If jitter is high at node 502, the tree branches to node 506, where latency is evaluated. If latency is high at node 506, the tree branches to leaf node 508, where no anomaly is detected. If latency is low at node 506, the tree branches to leaf node 510, where an anomaly is detected.

In a real-time scenario where the decision tree model 500 is used to process live QoS data, the model 500 predicts whether or not there is an anomaly, and if there is an anomaly, then what is the spatial source for the anomaly. The information about the anomaly may be sent to the system administrator to perform further troubleshooting and corrective actions. If there is no anomaly, then the model may suggest the correct network calibration.

FIGS. 6A-B illustrate examples of recurrent neural networks (RNN), which may be used to detect interference and anomalies and/or provide tuning recommendations for wireless networks based on radio frequency (RF) spectrum data. In particular, FIG. 6A illustrates a standard RNN 600, while FIG. 6B illustrates a long short-term memory (LSTM) network 610.

An RNN 600 is a type of deep-learning artificial neural network designed to process sequential data using the concept of “recurrence.” For example, an RNN leverages internal memory/states and feedback connections to capture and utilize context from previous inputs. This allows the RNN to capture dependencies and patterns in sequential data, which makes it suitable for tasks such as language modeling, speech recognition, machine translation, sentiment analysis, and time-series prediction.

Unlike feedforward neural networks, which process data in a strictly sequential manner from input to output, RNNs have feedback connections that allow information or context to be shared across multiple inputs. For example, while a feedforward neural network establishes weighted connections between layers, an RNN establishes weighted connections between layers and between neurons of the same layer (e.g., where the output of some nodes serve as input to those same nodes), which enables the RNN to learn from time-sequential data.

The fundamental building block of an RNN is a recurrent neuron, which receives an input as well as the output from the previous step. This enables the neuron to incorporate information from earlier steps into its current computation. The output of each recurrent neuron is then fed back into the network, creating a loop that allows the network to maintain and update its internal memory as it processes the sequential data.

An LSTM network 610 is a type of RNN capable of learning long-term dependencies in sequential data, which is particularly useful for sequence prediction problems.

LSTM networks use memory cells and gating mechanisms to capture and retain (or “remember”) information over long sequences of data. For example, each LSTM layer is made up of several LSTM units, and each unit typically includes a memory cell, an input gate, a forget gate, and an output gate. The memory cell remembers values over arbitrary time intervals and the three gates regulate the flow of information into and out of the cell.

The input gate determines which information from the current input and the previous hidden state should be stored in the memory cell. The forget gate determines which information should be discarded from the memory cell. The output gate determines which information from the memory cell should be output to the next hidden state.

These gates are learned during the training process, allowing an LSTM network to adaptively decide what information to retain or forget at each time step. The presence of these gates and the memory cells within LSTM networks make them particularly effective at learning long-term dependencies in sequential data.

The following equations define the input gate (i), forget gate (f), output gate (o), candidate cell state (g) (e.g., new information to be passed to the cell state), cell state (C), and cell output (h) for an LSTM unit, where a is the logistic sigmoid function, W is the weight matrix, b is the bias vector, x is the input vector, and t is time:

iₜ=σ(Wₕᵢhₜ₋₁+Wₓᵢxₜ+bᵢ)

fₜ=σ(W_{hf}hₜ₋₁+W_{xf}xₜ+b_{f})

oₜ=σ(Wₕₒhₜ₋₁+Wₓₒxₜ+bₒ)

gₜ=tan h(W_{hc}hₜ₋₁+W_{xc}xₜ+b_{c})

Cₜ=fₜCₜ₋₁+(1−fₜ)gₜ

hₜ=oₜ tan h(Cₜ)

As described above, an LSTM model can be used to process radio frequency (RF) data to detect interference and other anomalies and provide tuning recommendations for wireless networks to improve performance. In this use case, the input vector x contains the radio frequency data samples, where the length of the vector is equal to the number of timestamps (t) or samples that are being considered to train the model.

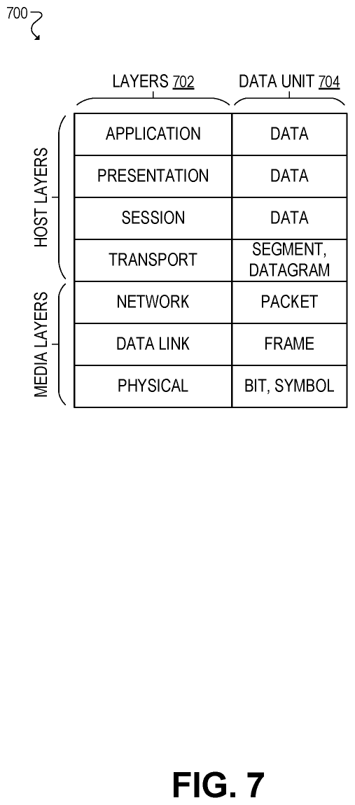

FIG. 7 illustrates an example of a protocol stack 700 for networking technologies. The protocols used for networking and communication technologies are commonly portrayed as “layers” 702 in a stack of protocols 700, as each protocol layer 702 has well-defined functions (e.g., based on standardized communication protocols) and typically communicates or interacts with neighboring protocols in the layers 702 immediately above and/or below. For example, the lowest protocol layer (e.g., physical layer) typically handles transmission of raw bits or symbols across a physical transmission medium (e.g., radio waves, wires/cables), while the highest protocol layer (e.g., application layer) typically provides application-level functions.

In the illustrated example, protocol stack 700 is based on the Open Systems Interconnection (OSI) model, which abstracts networking and communication protocols into the following protocol layers 702: physical layer, data link layer, network layer, transport layer, session layer, presentation layer, and application layer. The respective layers 702 and corresponding data units 704 of protocol stack 700 are described below in Table 2.

For wireless networking and communication technologies (e.g., cellular, Wi-Fi, Bluetooth, LR-WPAN), the actual wireless transmissions are typically implemented in the lowest-level layers 702 of the protocol stack 700, such as the physical and data link layers, using radio waves as the physical layer transmission medium.

TABLE 2
Example Protocol Stack

| | | | PROTOCOL | |
|---|---|---|---|---|
| | LAYER | | DATA UNIT | DESCRIPTION |
| HOST | 7 | Application | Data | High-level protocols and interfaces for providing |
| LAYERS | | | | application services, such as web services, file |
| | | | | sharing, resource sharing, message handling, and |
| | | | | database access (e.g., HTTP, FTP, SSH) |
| | 6 | Presentation | Data | Data translation, representation, and formatting |
| | | | | (e.g., protocol conversion, character encoding, |
| | | | | compression/decompression, encryption/ |
| | | | | decryption), such as translating incoming and |
| | | | | outgoing data into a format specified by the |
| | | | | application layer |
| | 5 | Session | Data | Managing a communication session between |
| | | | | nodes (e.g., back-and-forth transmissions) |
| | 4 | Transport | Segment, | End-to-end communication services, such as |
| | | | Datagram | connection-oriented communication, reliability, |
| | | | | flow control, and multiplexing (e.g., Transmission |
| | | | | Control Protocol (TCP), User Datagram Protocol |
| | | | | (UDP)) |
| MEDIA | 3 | Network | Packet | Transmission of packets between nodes |
| LAYERS | | | | connected over a network, including addressing, |
| | | | | packet forwarding, and routing (e.g., Internet |
| | | | | Protocol (IP)) |
| | 2 | Data Link | Frame | Transmission of data frames between nodes |
| | | | | directly connected via the physical layer (direct |
| | | | | node-to-node transfer), including media access |
| | | | | control (MAC) and logical link control (LLC) |
| | | | | (e.g., IEEE 802.2, Ethernet (IEEE 802.3), Wi-Fi |
| | | | | (IEEE 802.11), LR-WPAN (IEEE 802.15.4), |
| | | | | Bluetooth, cellular) |
| | 1 | Physical | Bit, Symbol | Transmission of raw bits or symbols over a |
| | | | | physical medium, such as radio waves (for |
| | | | | wireless technologies) or wires/cables (for wired |
| | | | | technologies) (e.g., Ethernet (IEEE 802.3), Wi-Fi |
| | | | | (IEEE 802.11), LR-WPAN (IEEE 802.15.4), |
| | | | | Bluetooth, cellular) |

It should be appreciated that protocol stack 700 is only one example methodology for representing the respective protocols and their associated relationships for networking technologies. In other protocol stacks, certain layers may be omitted, added, combined, or split. For example, in the Internet protocol suite, the physical and data link layers of the OSI model are combined into a single link layer, and all layers above the transport layer in the OSI model (e.g., the session, presentation, and application layers) are combined into a single application layer.

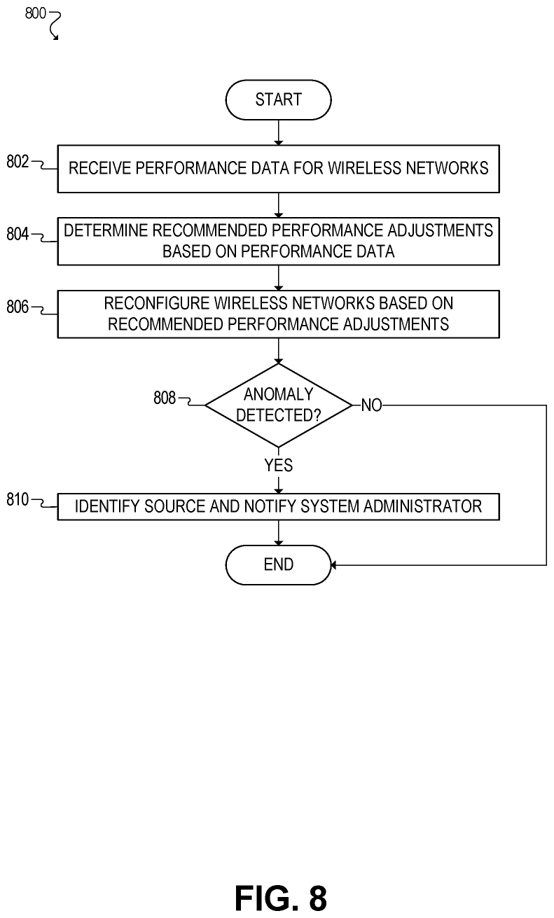

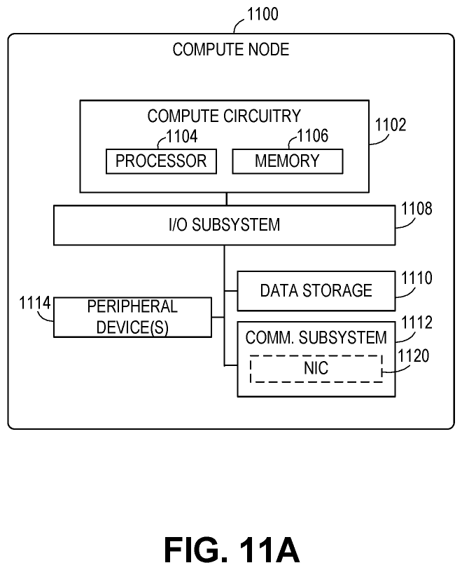

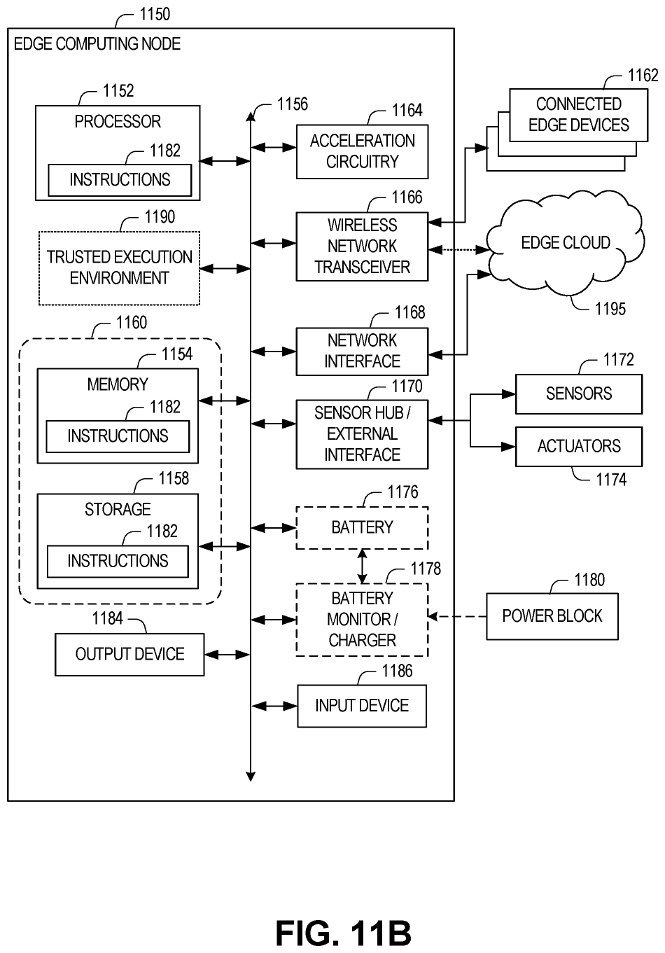

FIG. 8 illustrates a flowchart 800 for automatically tuning wireless infrastructure in accordance with certain embodiments. The process flow may be performed using any type or combination of circuitry, including, without limitation, processing circuitry (e.g., CPUs, GPUs, AI/ML accelerators, digital signal processors), interface circuitry, communication circuitry, and/or transceiver circuitry, which may be part of a single device or distributed across multiple devices. In some embodiments, flowchart 800 may be performed using the example computing devices and systems described throughout this disclosure (e.g., system 100, compute devices 1100, 1150 of FIGS. 11A-B).

In the illustrated example, the process flow is used to automatically tune wireless infrastructure. The wireless infrastructure may include network nodes and equipment (e.g., access points, base stations, networking equipment and servers) associated with multiple wireless networks deployed in an environment. In some embodiments, the wireless networks may be based on various heterogenous wireless technologies, including, without limitation, cellular (e.g., 4G, 5G), Wi-Fi, Bluetooth, and/or IEEE 802.15.4 Low-Rate Wireless Personal Area Network (LR-WPAN) (e.g., WirelessHART, Zigbee, ISA100.11a, MiWi, 6LoWPAN, Thread, SNAP). For example, in some cases, the infrastructure may include networks that are based on cellular technology, Wi-Fi, Bluetooth, and/or IEEE 802.15.4 LR-WPAN technology, or a subset or superset thereof. A wireless technology may refer to any technology used to communicate at least partially via wireless transmissions, such as via radio frequency (RF) transmissions over certain frequency ranges or bands of the RF spectrum. Different wireless technologies may have different respective frequency spectrums, which may or may not overlap. A wireless network may refer to any mechanism of communication that relies at least partially on a wireless technology.

The process flow begins at block 802 by receiving performance data for the respective wireless networks deployed in the environment. In some embodiments, the performance data may be received from various sources (e.g., via interface circuitry) and may include various types of information that are indicative of the performance of the respective wireless networks. Moreover, the performance data may be based on multiple protocol layers of the respective wireless technologies. For example, the wireless technologies used to implement the various wireless networks may be based on corresponding protocol stacks, and the performance data may be based on the protocol layers from multiple different levels of the protocol stacks, such as the physical layer, data link layer, network layer, and/or transport layer.

As an example, for an infrastructure with cellular, Wi-Fi, and Bluetooth networks, the performance data could be based on: the physical and data link layers of the cellular network; the physical, data link, network, and transport layers of the Wi-Fi network, and the physical layer of the Bluetooth network. It should be appreciated that this combination of wireless technologies and protocol layers is merely provided as an example, as the performance data can be based on any combination of wireless technologies and protocol layers in actual embodiments.

In some embodiments, for example, the performance data may include quality of service (QoS) metric(s) for some or all of the wireless networks, radio frequency (RF) spectrum data, and/or spatiotemporal performance data.

The QoS metrics may be indicative of information such as signal quality (e.g., signal strength, signal-to-noise ratio), demodulation errors, data transmission errors, network layer performance, and/or transport layer performance, among other examples.

The RF spectrum data may be indicative of the frequency bands in the RF spectrum that are currently in use in the environment and/or their associated energy levels (e.g., based on an analysis of RF signals detected at various frequencies by one or more RF receivers deployed in the environment, which may be independent of the wireless networks).

The spatiotemporal performance data may include various types of contextual information indicative of the performance of certain wireless network(s) based on time and location, including, without limitation, the network layout, historical network load, device locations and density, calendar/scheduling information (e.g., work/personal days, business hours, business schedules, events), vehicular traffic patterns, geographical topography (e.g., mountains, buildings), and weather conditions. This spatiotemporal data may be provided using any appropriate granularity of time and/or location. For example, with respect to time, certain spatiotemporal data may be provided based on the time of day, day of week, weekday vs. weekend, holidays, and so forth. With respect to location, certain spatiotemporal data may be provided based on government-defined boundaries (e.g., address, street, neighborhood, city, zip code, state, territory, country), geographical boundaries (e.g., mountains, rivers, lakes, oceans), location coordinates (e.g., latitude/longitude), and/or coverage areas (e.g., coverage areas of specific networks, base stations, access points, etc.).

The process flow then proceeds to block 804 to determine recommended performance adjustments based on the performance data. In some embodiments, for example, the performance data may be used to determine one or more configuration settings to be adjusted for one or more of the wireless networks. For example, the one or more configuration settings may include one or more modulation settings, transmission power settings, operating channel settings, radio resource management settings, and/or quality of service settings.

In some embodiments, the one or more configuration settings may be determined from the performance data using a machine learning (MIL) model that is trained to infer configuration adjustments based on past performance data and/or past configuration data for the wireless networks and/or wireless technologies.

Further, in some embodiments, the one or more configuration settings may also be determined based on one or more performance objectives, such as traffic flow objective(s) that indicate a priority among various traffic flows on the wireless networks.

The process flow then proceeds to block 806 to reconfigure at least some of the wireless networks based on the recommended performance adjustments. In some embodiments, for example, the configuration settings identified in or otherwise derived from the recommended performance adjustments may be adjusted for the applicable wireless networks.

The process flow then proceeds to block 808 to determine whether an anomaly is detected (e.g., significant signal interference). In some embodiments, for example, the RF spectrum data and/or other performance data may be used to detect one or more sources of signal interference or anomalies for one or more of the wireless networks. For example, the signal interference may be caused by transmissions from one or more devices (e.g., devices that are physically separate/independent and/or have physically separate/independent housings). In some embodiments, the sources of signal interference or anomalies may be detected from the RF spectrum data using an ML model trained to infer sources of interference and/or anomalies based on past RF spectrum data.

If no anomalies are detected, the process flow may be complete. If an anomaly is detected, however, the process flow proceeds to block 810 to identify the source(s) of the anomaly and/or notify a system administrator. Further, in some embodiments, when an anomaly is detected, the process flow may proceed back to block 804 to determine recommended performance adjustments based at least in part on the detected anomaly.

At this point, the process flow may be complete. In some embodiments, however, the process flow may restart and/or certain blocks may be repeated. For example, in some embodiments, the process flow may restart at block 802 to continue tuning the performance of the heterogenous wireless infrastructure.

### Computing Embodiments

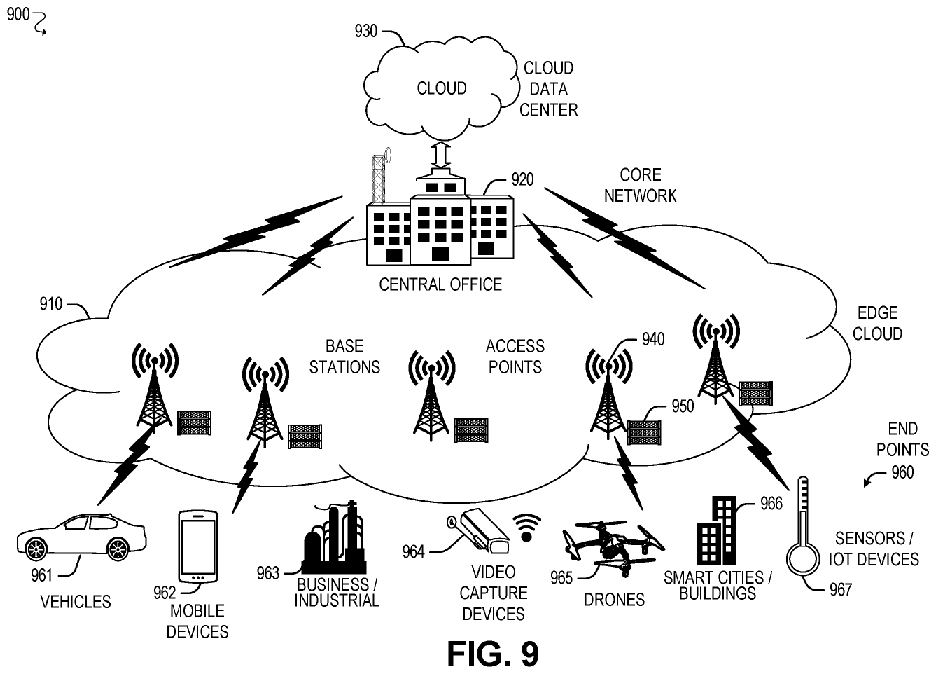

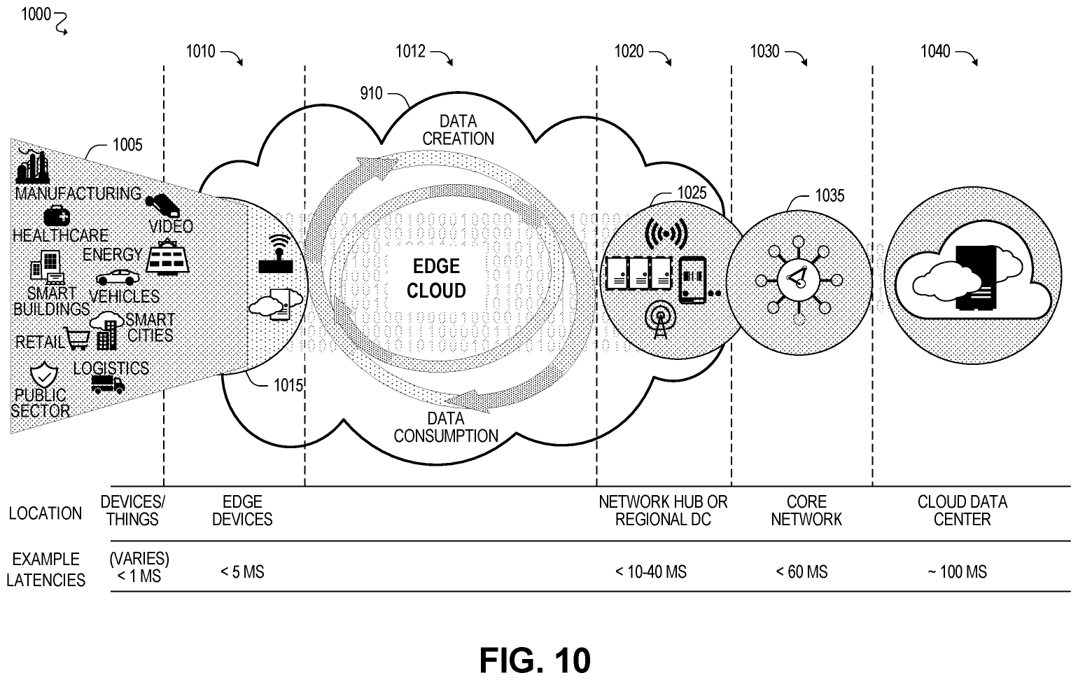

Examples of various computing embodiments that may be used to implement the wireless network tuning solution described herein are provided below. In particular, any aspects of the solution described in the preceding sections may be implemented using the embodiments described below. In some embodiments, for example, the wireless network tuning solution may be implemented in the edge computing environments of FIGS. 9-10 and/or using the computing devices of FIGS. 11A-B.

Edge Computing

FIG. 9 is a block diagram 900 showing an overview of a configuration for Edge computing, which includes a layer of processing referred to in many of the following examples as an “Edge cloud”. As shown, the Edge cloud 910 is co-located at an Edge location, such as an access point or base station 940, a local processing hub 950, or a central office 920, and thus may include multiple entities, devices, and equipment instances. The Edge cloud 910 is located much closer to the endpoint (consumer and producer) data sources 960 (e.g., autonomous vehicles 961, user equipment 962, business and industrial equipment 963, video capture devices 964, drones 965, smart cities and building devices 966, sensors and IoT devices 967, etc.) than the cloud data center 930. Compute, memory, and storage resources which are offered at the edges in the Edge cloud 910 are critical to providing ultra-low latency response times for services and functions used by the endpoint data sources 960 as well as reduce network backhaul traffic from the Edge cloud 910 toward cloud data center 930 thus improving energy consumption and overall network usages among other benefits.

Compute, memory, and storage are scarce resources, and generally decrease depending on the Edge location (e.g., fewer processing resources being available at consumer endpoint devices, than at a base station, than at a central office). However, the closer that the Edge location is to the endpoint (e.g., user equipment (UE)), the more that space and power is often constrained. Thus, Edge computing attempts to reduce the amount of resources needed for network services, through the distribution of more resources which are located closer both geographically and in network access time. In this manner, Edge computing attempts to bring the compute resources to the workload data where appropriate, or, bring the workload data to the compute resources.

The following describes aspects of an Edge cloud architecture that covers multiple potential deployments and addresses restrictions that some network operators or service providers may have in their own infrastructures. These include, variation of configurations based on the Edge location (because edges at a base station level, for instance, may have more constrained performance and capabilities in a multi-tenant scenario); configurations based on the type of compute, memory, storage, fabric, acceleration, or like resources available to Edge locations, tiers of locations, or groups of locations; the service, security, and management and orchestration capabilities; and related objectives to achieve usability and performance of end services. These deployments may accomplish processing in network layers that may be considered as “near Edge”, “close Edge”, “local Edge”, “middle Edge”, or “far Edge” layers, depending on latency, distance, and timing characteristics.

Edge computing is a developing paradigm where computing is performed at or closer to the “Edge” of a network, typically through the use of a compute platform (e.g., x86 or ARM compute hardware architecture) implemented at base stations, gateways, network routers, or other devices which are much closer to endpoint devices producing and consuming the data. For example, Edge gateway servers may be equipped with pools of memory and storage resources to perform computation in real-time for low latency use-cases (e.g., autonomous driving or video surveillance) for connected client devices. Or as an example, base stations may be augmented with compute and acceleration resources to directly process service workloads for connected user equipment, without further communicating data via backhaul networks. Or as another example, central office network management hardware may be replaced with standardized compute hardware that performs virtualized network functions and offers compute resources for the execution of services and consumer functions for connected devices. Within Edge computing networks, there may be scenarios in services which the compute resource will be “moved” to the data, as well as scenarios in which the data will be “moved” to the compute resource. Or as an example, base station compute, acceleration and network resources can provide services in order to scale to workload demands on an as needed basis by activating dormant capacity (subscription, capacity on demand) in order to manage corner cases, emergencies or to provide longevity for deployed resources over a significantly longer implemented lifecycle.

FIG. 10 illustrates operational layers among endpoints, an Edge cloud, and cloud computing environments. Specifically, FIG. 10 depicts examples of computational use cases 1005, utilizing the Edge cloud 910 among multiple illustrative layers of network computing. The layers begin at an endpoint (devices and things) layer 1000, which accesses the Edge cloud 910 to conduct data creation, analysis, and data consumption activities. The Edge cloud 910 may span multiple network layers, such as an Edge devices layer 1010 having gateways, on-premise servers, or network equipment (nodes 1015) located in physically proximate Edge systems; a network access layer 1020, encompassing base stations, radio processing units, network hubs, regional data centers (DC), or local network equipment (equipment 1025); and any equipment, devices, or nodes located therebetween (in layer 1012, not illustrated in detail). The network communications within the Edge cloud 910 and among the various layers may occur via any number of wired or wireless mediums, including via connectivity architectures and technologies not depicted.

Examples of latency, resulting from network communication distance and processing time constraints, may range from less than a millisecond (ms) when among the endpoint layer 1000, under 5 ms at the Edge devices layer 1010, to even between 10 to 40 ms when communicating with nodes at the network access layer 1020. Beyond the Edge cloud 910 are core network 1030 and cloud data center 1040 layers, each with increasing latency (e.g., between 50-60 ms at the core network layer 1030, to 100 or more ms at the cloud data center layer). As a result, operations at a core network data center 1035 or a cloud data center 1045, with latencies of at least 50 to 100 ms or more, will not be able to accomplish many time-critical functions of the use cases 1005. Each of these latency values are provided for purposes of illustration and contrast; iₜ will be understood that the use of other access network mediums and technologies may further reduce the latencies. In some examples, respective portions of the network may be categorized as “close Edge”, “local Edge”, “near Edge”, “middle Edge”, or “far Edge” layers, relative to a network source and destination. For instance, from the perspective of the core network data center 1035 or a cloud data center 1045, a central office or content data network may be considered as being located within a “near Edge” layer (“near” to the cloud, having high latency values when communicating with the devices and endpoints of the use cases 1005), whereas an access point, base station, on-premise server, or network gateway may be considered as located within a “far Edge” layer (“far” from the cloud, having low latency values when communicating with the devices and endpoints of the use cases 1005). It will be understood that other categorizations of a particular network layer as constituting a “close”, “local”, “near”, “middle”, or “far” Edge may be based on latency, distance, number of network hops, or other measurable characteristics, as measured from a source in any of the network layers 1000-1040.

The various use cases 1005 may access resources under usage pressure from incoming streams, due to multiple services utilizing the Edge cloud. To achieve results with low latency, the services executed within the Edge cloud 910 balance varying requirements in terms of: (a) Priority (throughput or latency) and Quality of Service (QoS) (e.g., traffic for an autonomous car may have higher priority than a temperature sensor in terms of response time requirement; or, a performance sensitivity/bottleneck may exist at a compute/accelerator, memory, storage, or network resource, depending on the application); (b) Reliability and Resiliency (e.g., some input streams need to be acted upon and the traffic routed with mission-critical reliability, where as some other input streams may be tolerate an occasional failure, depending on the application); and (c) Physical constraints (e.g., power, cooling and form-factor, etc.).

The end-to-end service view for these use cases involves the concept of a service-flow and is associated with a transaction. The transaction details the overall service requirement for the entity consuming the service, as well as the associated services for the resources, workloads, workflows, and business functional and business level requirements. The services executed with the “terms” described may be managed at each layer in a way to assure real time, and runtime contractual compliance for the transaction during the lifecycle of the service. When a component in the transaction is missing its agreed to Service Level Agreement (SLA), the system as a whole (components in the transaction) may provide the ability to (1) understand the impact of the SLA violation, and (2) augment other components in the system to resume overall transaction SLA, and (3) implement steps to remediate.

Thus, with these variations and service features in mind, Edge computing within the Edge cloud 910 may provide the ability to serve and respond to multiple applications of the use cases 1005 (e.g., object tracking, video surveillance, connected cars, etc.) in real-time or near real-time, and meet ultra-low latency requirements for these multiple applications. These advantages enable a whole new class of applications (e.g., Virtual Network Functions (VNFs), Function as a Service (FaaS), Edge as a Service (EaaS), standard processes, etc.), which cannot leverage conventional cloud computing due to latency or other limitations.

However, with the advantages of Edge computing comes the following caveats. The devices located at the Edge are often resource constrained and therefore there is pressure on usage of Edge resources. Typically, this is addressed through the pooling of memory and storage resources for use by multiple users (tenants) and devices. The Edge may be power and cooling constrained and therefore the power usage needs to be accounted for by the applications that are consuming the most power. There may be inherent power-performance tradeoffs in these pooled memory resources, as many of them are likely to use emerging memory technologies, where more power requires greater memory bandwidth. Likewise, improved security of hardware and root of trust trusted functions are also required, because Edge locations may be unmanned and may even need permissioned access (e.g., when housed in a third-party location). Such issues are magnified in the Edge cloud 910 in a multi-tenant, multi-owner, or multi-access setting, where services and applications are requested by many users, especially as network usage dynamically fluctuates and the composition of the multiple stakeholders, use cases, and services changes.

At a more generic level, an Edge computing system may be described to encompass any number of deployments at the previously discussed layers operating in the Edge cloud 910 (network layers 1000-1040), which provide coordination from client and distributed computing devices. One or more Edge gateway nodes, one or more Edge aggregation nodes, and one or more core data centers may be distributed across layers of the network to provide an implementation of the Edge computing system by or on behalf of a telecommunication service provider (“telco”, or “TSP”), internet-of-things service provider, cloud service provider (CSP), enterprise entity, or any other number of entities. Various implementations and configurations of the Edge computing system may be provided dynamically, such as when orchestrated to meet service objectives.

Consistent with the examples provided herein, a client compute node may be embodied as any type of endpoint component, device, appliance, or other thing capable of communicating as a producer or consumer of data. Further, the label “node” or “device” as used in the Edge computing system does not necessarily mean that such node or device operates in a client or agent/minion/follower role; rather, any of the nodes or devices in the Edge computing system refer to individual entities, nodes, or subsystems which include discrete or connected hardware or software configurations to facilitate or use the Edge cloud 910.

As such, the Edge cloud 910 is formed from network components and functional features operated by and within Edge gateway nodes, Edge aggregation nodes, or other Edge compute nodes among network layers 1010-1030. The Edge cloud 910 thus may be embodied as any type of network that provides Edge computing and/or storage resources which are proximately located to radio access network (RAN) capable endpoint devices (e.g., mobile computing devices, IoT devices, smart devices, etc.), which are discussed herein. In other words, the Edge cloud 910 may be envisioned as an “Edge” which connects the endpoint devices and traditional network access points that serve as an ingress point into service provider core networks, including mobile carrier networks (e.g., Global System for Mobile Communications (GSM) networks, Long-Term Evolution (LTE) networks, 5G/6G networks, etc.), while also providing storage and/or compute capabilities. Other types and forms of network access (e.g., Wi-Fi, long-range wireless, wired networks including optical networks, etc.) may also be utilized in place of or in combination with such 3GPP carrier networks.

The network components of the Edge cloud 910 may be servers, multi-tenant servers, appliance computing devices, and/or any other type of computing devices. For example, the Edge cloud 910 may include an appliance computing device that is a self-contained electronic device including a housing, a chassis, a case, or a shell. In some circumstances, the housing may be dimensioned for portability such that it can be carried by a human and/or shipped. Example housings may include materials that form one or more exterior surfaces that partially or fully protect contents of the appliance, in which protection may include weather protection, hazardous environment protection (e.g., electromagnetic interference (EMI), vibration, extreme temperatures, etc.), and/or enable submergibility. Example housings may include power circuitry to provide power for stationary and/or portable implementations, such as alternating current (AC) power inputs, direct current (DC) power inputs, AC/DC converter(s), DC/AC converter(s), DC/DC converter(s), power regulators, transformers, charging circuitry, batteries, wired inputs, and/or wireless power inputs. Example housings and/or surfaces thereof may include or connect to mounting hardware to enable attachment to structures such as buildings, telecommunication structures (e.g., poles, antenna structures, etc.), and/or racks (e.g., server racks, blade mounts, etc.). Example housings and/or surfaces thereof may support one or more sensors (e.g., temperature sensors, vibration sensors, light sensors, acoustic sensors, capacitive sensors, proximity sensors, infrared or other visual thermal sensors, etc.). One or more such sensors may be contained in, carried by, or otherwise embedded in the surface and/or mounted to the surface of the appliance. Example housings and/or surfaces thereof may support mechanical connectivity, such as propulsion hardware (e.g., wheels, rotors such as propellers, etc.) and/or articulating hardware (e.g., robot arms, pivotable appendages, etc.). In some circumstances, the sensors may include any type of input devices such as user interface hardware (e.g., buttons, switches, dials, sliders, microphones, etc.). In some circumstances, example housings include output devices contained in, carried by, embedded therein and/or attached thereto. Output devices may include displays, touchscreens, lights, light-emitting diodes (LEDs), speakers, input/output (I/O) ports (e.g., universal serial bus (USB)), etc. In some circumstances, Edge devices are devices presented in the network for a specific purpose (e.g., a traffic light), but may have processing and/or other capacities that may be utilized for other purposes. Such Edge devices may be independent from other networked devices and may be provided with a housing having a form factor suitable for its primary purpose; yet be available for other compute tasks that do not interfere with its primary task. Edge devices include Internet of Things devices. The appliance computing device may include hardware and software components to manage local issues such as device temperature, vibration, resource utilization, updates, power issues, physical and network security, etc. Example hardware for implementing an appliance computing device is described in conjunction with FIG. 11B. The Edge cloud 910 may also include one or more servers and/or one or more multi-tenant servers. Such a server may include an operating system and implement a virtual computing environment. A virtual computing environment may include a hypervisor managing (e.g., spawning, deploying, commissioning, destroying, decommissioning, etc.) one or more virtual machines, one or more containers, etc. Such virtual computing environments provide an execution environment in which one or more applications and/or other software, code, or scripts may execute while being isolated from one or more other applications, software, code, or scripts.

Computing Devices and Systems

In further examples, any of the compute nodes or devices discussed with reference to the present Edge computing systems and environment may be fulfilled based on the components depicted in FIGS. 11A and 111B. Respective Edge compute nodes may be embodied as a type of device, appliance, computer, or other “thing” capable of communicating with other Edge, networking, or endpoint components. For example, an Edge compute device may be embodied as a personal computer, server, smartphone, a mobile compute device, a smart appliance, an in-vehicle compute system (e.g., a navigation system), a self-contained device having an outer case, shell, etc., or other device or system capable of performing the described functions.

In the simplified example depicted in FIG. 11A, an Edge compute node 1100 includes a compute engine (also referred to herein as “compute circuitry”) 1102, an input/output (I/O) subsystem (also referred to herein as “I/O circuitry”) 1108, data storage (also referred to herein as “data storage circuitry”) 1110, a communication circuitry subsystem 1112, and, optionally, one or more peripheral devices (also referred to herein as “peripheral device circuitry”) 1114. In other examples, respective compute devices may include other or additional components, such as those typically found in a computer (e.g., a display, peripheral devices, etc.). Additionally, in some examples, one or more of the illustrative components may be incorporated in, or otherwise form a portion of, another component.

The compute node 1100 may be embodied as any type of engine, device, or collection of devices capable of performing various compute functions. In some examples, the compute node 1100 may be embodied as a single device such as an integrated circuit, an embedded system, a field-programmable gate array (FPGA), a system-on-a-chip (SOC), or other integrated system or device. In the illustrative example, the compute node 1100 includes or is embodied as a processor (also referred to herein as “processor circuitry”) 1104 and a memory (also referred to herein as “memory circuitry”) 1106. The processor 1104 may be embodied as any type of processor(s) capable of performing the functions described herein (e.g., executing an application). For example, the processor 1104 may be embodied as a multi-core processor(s), a microcontroller, a processing unit, a specialized or special purpose processing unit, or other processor or processing/controlling circuit.

In some examples, the processor 1104 may be embodied as, include, or be coupled to an FPGA, an application specific integrated circuit (ASIC), reconfigurable hardware or hardware circuitry, or other specialized hardware to facilitate performance of the functions described herein. Also in some examples, the processor D104 may be embodied as a specialized x-processing unit (xPU) also known as a data processing unit (DPU), infrastructure processing unit (IPU), or network processing unit (NPU). Such an xPU may be embodied as a standalone circuit or circuit package, integrated within an SOC, or integrated with networking circuitry (e.g., in a SmartNIC, or enhanced SmartNIC), acceleration circuitry, storage devices, storage disks, or AI hardware (e.g., GPUs, programmed FPGAs, or ASICs tailored to implement an AI model such as a neural network). Such an xPU may be designed to receive, retrieve, and/or otherwise obtain programming to process one or more data streams and perform specific tasks and actions for the data streams (such as hosting microservices, performing service management or orchestration, organizing or managing server or data center hardware, managing service meshes, or collecting and distributing telemetry), outside of the CPU or general purpose processing hardware. However, it will be understood that an xPU, an SOC, a CPU, and other variations of the processor 1104 may work in coordination with each other to execute many types of operations and instructions within and on behalf of the compute node 1100.

The memory 1106 may be embodied as any type of volatile (e.g., dynamic random access memory (DRAM), etc.) or non-volatile memory or data storage capable of performing the functions described herein. Volatile memory may be a storage medium that requires power to maintain the state of data stored by the medium. Non-limiting examples of volatile memory may include various types of random access memory (RAM), such as DRAM or static random access memory (SRAM). One particular type of DRAM that may be used in a memory module is synchronous dynamic random access memory (SDRAM).

In an example, the memory device (e.g., memory circuitry) is any number of block addressable memory devices, such as those based on NAND or NOR technologies (for example, Single-Level Cell (“SLC”), Multi-Level Cell (“MLC”), Quad-Level Cell (“QLC”), Tri-Level Cell (“TLC”), or some other NAND). In some examples, the memory device(s) includes a byte-addressable write-in-place three dimensional crosspoint memory device, or other byte addressable write-in-place non-volatile memory (NVM) devices, such as single or multi-level Phase Change Memory (PCM) or phase change memory with a switch (PCMS), NVM devices that use chalcogenide phase change material (for example, chalcogenide glass), resistive memory including metal oxide base, oxygen vacancy base and Conductive Bridge Random Access Memory (CB-RAM), nanowire memory, ferroelectric transistor random access memory (FeTRAM), magneto resistive random access memory (MRAM) that incorporates memristor technology, spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, a combination of any of the above, or other suitable memory. A memory device may also include a three-dimensional crosspoint memory device (e.g., Intel® 3D XPoint™ memory), or other byte addressable write-in-place nonvolatile memory devices. The memory device may refer to the die itself and/or to a packaged memory product. In some examples, 3D crosspoint memory (e.g., Intel® 3D XPoint™ memory) may include a transistor-less stackable cross point architecture in which memory cells sit at the intersection of word lines and bit lines and are individually addressable and in which bit storage is based on a change in bulk resistance. In some examples, all or a portion of the memory 1106 may be integrated into the processor 1104. The memory 1106 may store various software and data used during operation such as one or more applications, data operated on by the application(s), libraries, and drivers.

In some examples, resistor-based and/or transistor-less memory architectures include nanometer scale phase-change memory (PCM) devices in which a volume of phase-change material resides between at least two electrodes. Portions of the example phase-change material exhibit varying degrees of crystalline phases and amorphous phases, in which varying degrees of resistance between the at least two electrodes can be measured. In some examples, the phase-change material is a chalcogenide-based glass material. Such resistive memory devices are sometimes referred to as memristive devices that remember the history of the current that previously flowed through them. Stored data is retrieved from example PCM devices by measuring the electrical resistance, in which the crystalline phases exhibit a relatively lower resistance value(s) (e.g., logical “0”) when compared to the amorphous phases having a relatively higher resistance value(s) (e.g., logical “1”).

Example PCM devices store data for long periods of time (e.g., approximately 10 years at room temperature). Write operations to example PCM devices (e.g., set to logical “0”, set to logical “1”, set to an intermediary resistance value) are accomplished by applying one or more current pulses to the at least two electrodes, in which the pulses have a particular current magnitude and duration. For instance, a long low current pulse (SET) applied to the at least two electrodes causes the example PCM device to reside in a low-resistance crystalline state, while a comparatively short high current pulse (RESET) applied to the at least two electrodes causes the example PCM device to reside in a high-resistance amorphous state.

In some examples, implementation of PCM devices facilitates non-von Neumann computing architectures that enable in-memory computing capabilities. Generally speaking, traditional computing architectures include a central processing unit (CPU) communicatively connected to one or more memory devices via a bus. As such, a finite amount of energy and time is consumed to transfer data between the CPU and memory, which is a known bottleneck of von Neumann computing architectures. However, PCM devices minimize and, in some cases, eliminate data transfers between the CPU and memory by performing some computing operations in-memory. Stated differently, PCM devices both store information and execute computational tasks. Such non-von Neumann computing architectures may implement vectors having a relatively high dimensionality to facilitate hyperdimensional computing, such as vectors having 10,000 bits. Relatively large bit width vectors enable computing paradigms modeled after the human brain, which also processes information analogous to wide bit vectors.

The compute circuitry 1102 is communicatively coupled to other components of the compute node 1100 via the I/O subsystem 1108, which may be embodied as circuitry and/or components to facilitate input/output operations with the compute circuitry 1102 (e.g., with the processor 1104 and/or the main memory 1106) and other components of the compute circuitry 1102. For example, the I/O subsystem 1108 may be embodied as, or otherwise include, memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some examples, the I/O subsystem 1108 may form a portion of a system-on-a-chip (SoC) and be incorporated, along with one or more of the processor 1104, the memory 1106, and other components of the compute circuitry 1102, into the compute circuitry 1102.

The one or more illustrative data storage devices/disks 1110 may be embodied as one or more of any type(s) of physical device(s) configured for short-term or long-term storage of data such as, for example, memory devices, memory, circuitry, memory cards, flash memory, hard disk drives (HDDs), solid-state drives (SSDs), and/or other data storage devices/disks. Individual data storage devices/disks 1110 may include a system partition that stores data and firmware code for the data storage device/disk 1110. Individual data storage devices/disks 1110 may also include one or more operating system partitions that store data files and executables for operating systems depending on, for example, the type of compute node 1100.

The communication circuitry 1112 may be embodied as any communication circuit, device, or collection thereof, capable of enabling communications over a network between the compute circuitry 1102 and another compute device (e.g., an Edge gateway of an implementing Edge computing system). The communication circuitry 1112 may be configured to use any one or more communication technology (e.g., wired or wireless communications) and associated protocols (e.g., a cellular networking protocol such a 3GPP 4G or 5G standard, a wireless local area network protocol such as IEEE 802.11/Wi-Fi®, a wireless wide area network protocol, Ethernet, Bluetooth®, Bluetooth Low Energy, a IoT protocol such as IEEE 802.15.4 or ZigBee®, low-power wide-area network (LPWAN) or low-power wide-area (LPWA) protocols, etc.) to effect such communication.

The illustrative communication circuitry 1112 includes a network interface controller (NIC) 1120, which may also be referred to as a host fabric interface (HFI). The NIC 1120 may be embodied as one or more add-in-boards, daughter cards, network interface cards, controller chips, chipsets, or other devices that may be used by the compute node 1100 to connect with another compute device (e.g., an Edge gateway node). In some examples, the NIC 1120 may be embodied as part of a system-on-a-chip (SoC) that includes one or more processors, or included on a multichip package that also contains one or more processors. In some examples, the NIC 1120 may include a local processor (not shown) and/or a local memory (not shown) that are both local to the NIC 1120. In such examples, the local processor of the NIC 1120 may be capable of performing one or more of the functions of the compute circuitry 1102 described herein. Additionally, or alternatively, in such examples, the local memory of the NIC 1120 may be integrated into one or more components of the client compute node at the board level, socket level, chip level, and/or other levels.

Additionally, in some examples, a respective compute node 1100 may include one or more peripheral devices 1114. Such peripheral devices 1114 may include any type of peripheral device found in a compute device or server such as audio input devices, a display, other input/output devices, interface devices, and/or other peripheral devices, depending on the particular type of the compute node 1100. In further examples, the compute node 1100 may be embodied by a respective Edge compute node (whether a client, gateway, or aggregation node) in an Edge computing system or like forms of appliances, computers, subsystems, circuitry, or other components.

In a more detailed example, FIG. 11B illustrates a block diagram of an example of components that may be present in an Edge computing node 1150 for implementing the techniques (e.g., operations, processes, methods, and methodologies) described herein. This Edge computing node 1150 provides a closer view of the respective components of node 1100 when implemented as or as part of a computing device (e.g., as a mobile device, a base station, server, gateway, etc.). The Edge computing node 1150 may include any combination of the hardware or logical components referenced herein, and it may include or couple with any device usable with an Edge communication network or a combination of such networks. The components may be implemented as integrated circuits (ICs), portions thereof, discrete electronic devices, or other modules, instruction sets, programmable logic or algorithms, hardware, hardware accelerators, software, firmware, or a combination thereof adapted in the Edge computing node 1150, or as components otherwise incorporated within a chassis of a larger system.

The Edge computing device 1150 may include processing circuitry in the form of a processor 1152, which may be a microprocessor, a multi-core processor, a multithreaded processor, an ultra-low voltage processor, an embedded processor, an xPU/DPU/IPU/NPU, special purpose processing unit, specialized processing unit, or other known processing elements. The processor 1152 may be a part of a system on a chip (SoC) in which the processor 1152 and other components are formed into a single integrated circuit, or a single package, such as the Edison™ or Galileo™ SoC boards from Intel Corporation, Santa Clara, California. As an example, the processor 1152 may include an Intel® Architecture Core™ based CPU processor, such as a Quark™, an Atom™, an i3, an i5, an i7, an i9, or an MCU-class processor, or another such processor available from Intel®. However, any number other processors may be used, such as available from Advanced Micro Devices, Inc. (AMD®) of Sunnyvale, California, a MIPS®-based design from MIPS Technologies, Inc. of Sunnyvale, California, an ARM®-based design licensed from ARM Holdings, Ltd. or a customer thereof, or their licensees or adopters. The processors may include units such as an A5-A13 processor from Apple® Inc., a Snapdragon™ processor from Qualcomm® Technologies, Inc., or an OMAP™ processor from Texas Instruments, Inc. The processor 1152 and accompanying circuitry may be provided in a single socket form factor, multiple socket form factor, or a variety of other formats, including in limited hardware configurations or configurations that include fewer than all elements shown in FIG. 11B.

The processor 1152 may communicate with a system memory 1154 over an interconnect 1156 (e.g., a bus). Any number of memory devices may be used to provide for a given amount of system memory. As examples, the memory D154 may be random access memory (RAM) in accordance with a Joint Electron Devices Engineering Council (JEDEC) design such as the DDR or mobile DDR standards (e.g., LPDDR, LPDDR2, LPDDR3, or LPDDR4). In particular examples, a memory component may comply with a DRAM standard promulgated by JEDEC, such as JESD79F for DDR SDRAM, JESD79-2F for DDR2 SDRAM, JESD79-3F for DDR3 SDRAM, JESD79-4A for DDR4 SDRAM, JESD209 for Low Power DDR (LPDDR), JESD209-2 for LPDDR2, JESD209-3 for LPDDR3, and JESD209-4 for LPDDR4. Such standards (and similar standards) may be referred to as DDR-based standards and communication interfaces of the storage devices that implement such standards may be referred to as DDR-based interfaces. In various implementations, the individual memory devices may be of any number of different package types such as single die package (SDP), dual die package (DDP) or quad die package (Q17P). These devices, in some examples, may be directly soldered onto a motherboard to provide a lower profile solution, while in other examples the devices are configured as one or more memory modules that in turn couple to the motherboard by a given connector. Any number of other memory implementations may be used, such as other types of memory modules, e.g., dual inline memory modules (DIMMs) of different varieties including but not limited to microDIMMs or MiniDIMMs.

To provide for persistent storage of information such as data, applications, operating systems and so forth, a storage 1158 may also couple to the processor 1152 via the interconnect 1156. In an example, the storage 1158 may be implemented via a solid-state disk drive (SSDD). Other devices that may be used for the storage 1158 include flash memory cards, such as Secure Digital (SD) cards, microSD cards, eXtreme Digital (XD) picture cards, and the like, and Universal Serial Bus (USB) flash drives. In an example, the memory device may be or may include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory.

In low power implementations, the storage 1158 may be on-die memory or registers associated with the processor 1152. However, in some examples, the storage 1158 may be implemented using a micro hard disk drive (HDD). Further, any number of new technologies may be used for the storage 1158 in addition to, or instead of, the technologies described, such resistance change memories, phase change memories, holographic memories, or chemical memories, among others.

The components may communicate over the interconnect 1156. The interconnect 1156 may include any number of technologies, including industry standard architecture (ISA), extended ISA (EISA), peripheral component interconnect (PCI), peripheral component interconnect extended (PCIx), PCI express (PCIe), or any number of other technologies. The interconnect 1156 may be a proprietary bus, for example, used in an SoC based system. Other bus systems may be included, such as an Inter-Integrated Circuit (I2C) interface, a Serial Peripheral Interface (SPI) interface, point to point interfaces, and a power bus, among others.

The interconnect 1156 may couple the processor 1152 to a transceiver 1166, for communications with the connected Edge devices 1162. The transceiver 1166 may use any number of frequencies and protocols, such as 2.4 Gigahertz (GHz) transmissions under the IEEE 802.15.4 standard, using the Bluetooth® low energy (BLE) standard, as defined by the Bluetooth® Special Interest Group, or the ZigBee® standard, among others. Any number of radios, configured for a particular wireless communication protocol, may be used for the connections to the connected Edge devices 1162. For example, a wireless local area network (WLAN) unit may be used to implement Wi-Fi® communications in accordance with the Institute of Electrical and Electronics Engineers (IEEE) 802.11 standard. In addition, wireless wide area communications, e.g., according to a cellular or other wireless wide area protocol, may occur via a wireless wide area network (WWAN) unit.

The wireless network transceiver 1166 (or multiple transceivers) may communicate using multiple standards or radios for communications at a different range. For example, the Edge computing node 1150 may communicate with close devices, e.g., within about 10 meters, using a local transceiver based on Bluetooth Low Energy (BLE), or another low power radio, to save power. More distant connected Edge devices 1162, e.g., within about 50 meters, may be reached over ZigBee® or other intermediate power radios. Both communications techniques may take place over a single radio at different power levels or may take place over separate transceivers, for example, a local transceiver using BLE and a separate mesh transceiver using ZigBee®.

A wireless network transceiver 1166 (e.g., a radio transceiver) may be included to communicate with devices or services in a cloud (e.g., an Edge cloud 1195) via local or wide area network protocols. The wireless network transceiver 1166 may be a low-power wide-area (LPWA) transceiver that follows the IEEE 802.15.4, or IEEE 802.15.4g standards, among others. The Edge computing node 1150 may communicate over a wide area using LoRaWAN™ (Long Range Wide Area Network) developed by Semtech and the LoRa Alliance. The techniques described herein are not limited to these technologies but may be used with any number of other cloud transceivers that implement long range, low bandwidth communications, such as Sigfox, and other technologies. Further, other communications techniques, such as time-slotted channel hopping, described in the IEEE 802.15.4e specification may be used.

Any number of other radio communications and protocols may be used in addition to the systems mentioned for the wireless network transceiver 1166, as described herein. For example, the transceiver 1166 may include a cellular transceiver that uses spread spectrum (SPA/SAS) communications for implementing high-speed communications. Further, any number of other protocols may be used, such as Wi-Fi® networks for medium speed communications and provision of network communications. The transceiver 1166 may include radios that are compatible with any number of 3GPP (Third Generation Partnership Project) specifications, such as Long Term Evolution (LTE) and 5th Generation (5G) communication systems, discussed in further detail at the end of the present disclosure. A network interface controller (NIC) 1168 may be included to provide a wired communication to nodes of the Edge cloud 1195 or to other devices, such as the connected Edge devices 1162 (e.g., operating in a mesh). The wired communication may provide an Ethernet connection or may be based on other types of networks, such as Controller Area Network (CAN), Local Interconnect Network (LIN), DeviceNet, ControlNet, Data Highway+, PROFIBUS, or PROFINET, among many others. An additional NIC 1168 may be included to enable connecting to a second network, for example, a first NIC 1168 providing communications to the cloud over Ethernet, and a second NIC 1168 providing communications to other devices over another type of network.

Given the variety of types of applicable communications from the device to another component or network, applicable communications circuitry used by the device may include or be embodied by any one or more of components 1164, 1166, 1168, or 1170. Accordingly, in various examples, applicable means for communicating (e.g., receiving, transmitting, etc.) may be embodied by such communications circuitry.

The Edge computing node 1150 may include or be coupled to acceleration circuitry 1164, which may be embodied by one or more artificial intelligence (AI) accelerators, a neural compute stick, neuromorphic hardware, an FPGA, an arrangement of GPUs, an arrangement of xPUs/DPUs/IPU/NPUs, one or more SoCs, one or more CPUs, one or more digital signal processors, dedicated ASICs, or other forms of specialized processors or circuitry designed to accomplish one or more specialized tasks. These tasks may include AI processing (including machine learning, training, inferencing, and classification operations), visual data processing, network data processing, object detection, rule analysis, or the like. These tasks also may include the specific Edge computing tasks for service management and service operations discussed elsewhere in this document.

The interconnect 1156 may couple the processor 1152 to a sensor hub or external interface 1170 that is used to connect additional devices or subsystems. The devices may include sensors 1172, such as accelerometers, level sensors, flow sensors, optical light sensors, camera sensors, temperature sensors, global navigation system (e.g., GPS) sensors, pressure sensors, barometric pressure sensors, and the like. The hub or interface 1170 further may be used to connect the Edge computing node 1150 to actuators 1174, such as power switches, valve actuators, an audible sound generator, a visual warning device, and the like.

In some optional examples, various input/output (I/O) devices may be present within or connected to, the Edge computing node 1150. For example, a display or other output device 1184 may be included to show information, such as sensor readings or actuator position. An input device 1186, such as a touch screen or keypad may be included to accept input. An output device 1184 may include any number of forms of audio or visual display, including simple visual outputs such as binary status indicators (e.g., light-emitting diodes (LEDs)) and multi-character visual outputs, or more complex outputs such as display screens (e.g., liquid crystal display (LCD) screens), with the output of characters, graphics, multimedia objects, and the like being generated or produced from the operation of the Edge computing node 1150. A display or console hardware, in the context of the present system, may be used to provide output and receive input of an Edge computing system; to manage components or services of an Edge computing system; identify a state of an Edge computing component or service; or to conduct any other number of management or administration functions or service use cases.

A battery 1176 may power the Edge computing node 1150, although, in examples in which the Edge computing node 1150 is mounted in a fixed location, it may have a power supply coupled to an electrical grid, or the battery may be used as a backup or for temporary capabilities. The battery 1176 may be a lithium ion battery, or a metal-air battery, such as a zinc-air battery, an aluminum-air battery, a lithium-air battery, and the like.

A battery monitor/charger 1178 may be included in the Edge computing node 1150 to track the state of charge (SoCh) of the battery 1176, if included. The battery monitor/charger 1178 may be used to monitor other parameters of the battery 1176 to provide failure predictions, such as the state of health (SoH) and the state of function (SoF) of the battery 1176. The battery monitor/charger 1178 may include a battery monitoring integrated circuit, such as an LTC4020 or an LTC2990 from Linear Technologies, an ADT7488A from ON Semiconductor of Phoenix Arizona, or an IC from the UCD90xxx family from Texas Instruments of Dallas, TX. The battery monitor/charger 1178 may communicate the information on the battery 1176 to the processor 1152 over the interconnect 1156. The battery monitor/charger 1178 may also include an analog-to-digital (ADC) converter that enables the processor 1152 to directly monitor the voltage of the battery 1176 or the current flow from the battery 1176. The battery parameters may be used to determine actions that the Edge computing node 1150 may perform, such as transmission frequency, mesh network operation, sensing frequency, and the like.

A power block 1180, or other power supply coupled to a grid, may be coupled with the battery monitor/charger 1178 to charge the battery 1176. In some examples, the power block 1180 may be replaced with a wireless power receiver to obtain the power wirelessly, for example, through a loop antenna in the Edge computing node 1150. A wireless battery charging circuit, such as an LTC4020 chip from Linear Technologies of Milpitas, California, among others, may be included in the battery monitor/charger 1178. The specific charging circuits may be selected based on the size of the battery 1176, and thus, the current required. The charging may be performed using the Airfuel standard promulgated by the Airfuel Alliance, the Qi wireless charging standard promulgated by the Wireless Power Consortium, or the Rezence charging standard, promulgated by the Alliance for Wireless Power, among others.

The storage 1158 may include instructions 1182 in the form of software, firmware, or hardware commands to implement the techniques described herein. Although such instructions 1182 are shown as code blocks included in the memory 1154 and the storage 1158, iₜ may be understood that any of the code blocks may be replaced with hardwired circuits, for example, built into an application specific integrated circuit (ASIC).

In an example, the instructions 1182 provided via the memory 1154, the storage 1158, or the processor 1152 may be embodied as a non-transitory, machine-readable medium 1160 including code to direct the processor 1152 to perform electronic operations in the Edge computing node 1150. The processor 1152 may access the non-transitory, machine-readable medium 1160 over the interconnect 1156. For instance, the non-transitory, machine-readable medium 1160 may be embodied by devices described for the storage 1158 or may include specific storage units such as storage devices and/or storage disks that include optical disks (e.g., digital versatile disk (DVD), compact disk (CD), CD-ROM, Blu-ray disk), flash drives, floppy disks, hard drives (e.g., SSDs), or any number of other hardware devices in which information is stored for any duration (e.g., for extended time periods, permanently, for brief instances, for temporarily buffering, and/or caching). The non-transitory, machine-readable medium 1160 may include instructions to direct the processor 1152 to perform a specific sequence or flow of actions, for example, as described with respect to the flowchart(s) and block diagram(s) of operations and functionality depicted above. As used herein, the terms “machine-readable medium” and “computer-readable medium” are interchangeable. As used herein, the term “non-transitory computer-readable medium” is expressly defined to include any type of computer readable storage device and/or storage disk and to exclude propagating signals and to exclude transmission media.

Also in a specific example, the instructions 1182 on the processor 1152 (separately, or in combination with the instructions 1182 of the machine readable medium 1160) may configure execution or operation of a trusted execution environment (TEE) 1190. In an example, the TEE 1190 operates as a protected area accessible to the processor 1152 for secure execution of instructions and secure access to data. Various implementations of the TEE 1190, and an accompanying secure area in the processor 1152 or the memory 1154 may be provided, for instance, through use of Intel® Software Guard Extensions (SGX) or ARM® TrustZone® hardware security extensions, Intel® Management Engine (ME), or Intel® Converged Security Manageability Engine (CSME). Other aspects of security hardening, hardware roots-of-trust, and trusted or protected operations may be implemented in the device 1150 through the TEE 1190 and the processor 1152.

While the illustrated examples of FIG. D1A and FIG. D1B include example components for a compute node and a computing device, respectively, examples disclosed herein are not limited thereto. As used herein, a “computer” may include some or all of the example components of FIGS. D1A and/or D1B in different types of computing environments. Example computing environments include Edge computing devices (e.g., Edge computers) in a distributed networking arrangement such that particular ones of participating Edge computing devices are heterogenous or homogeneous devices. As used herein, a “computer” may include a personal computer, a server, user equipment, an accelerator, etc., including any combinations thereof. In some examples, distributed networking and/or distributed computing includes any number of such Edge computing devices as illustrated in FIGS. D1A and/or D1B, each of which may include different sub-components, different memory capacities, I/O capabilities, etc. For example, because some implementations of distributed networking and/or distributed computing are associated with particular desired functionality, examples disclosed herein include different combinations of components illustrated in FIGS. D1A and/or D1B to satisfy functional objectives of distributed computing tasks. In some examples, the term “compute node” or “computer” only includes the example processor D104, memory D106 and I/O subsystem D108 of FIG. D1A. In some examples, one or more objective functions of a distributed computing task(s) rely on one or more alternate devices/structure located in different parts of an Edge networking environment, such as devices to accommodate data storage (e.g., the example data storage D1110), input/output capabilities (e.g., the example peripheral device(s) D114), and/or network communication capabilities (e.g., the example NIC D120).

In some examples, computers operating in a distributed computing and/or distributed networking environment (e.g., an Edge network) are structured to accommodate particular objective functionality in a manner that reduces computational waste. For instance, because a computer includes a subset of the components disclosed in FIGS. D1A and D1B, such computers satisfy execution of distributed computing objective functions without including computing structure that would otherwise be unused and/or underutilized. As such, the term “computer” as used herein includes any combination of structure of FIGS. D1A and/or D1B that is capable of satisfying and/or otherwise executing objective functions of distributed computing tasks. In some examples, computers are structured in a manner commensurate to corresponding distributed computing objective functions in a manner that downscales or upscales in connection with dynamic demand. In some examples, different computers are invoked and/or otherwise instantiated in view of their ability to process one or more tasks of the distributed computing request(s), such that any computer capable of satisfying the tasks proceed with such computing activity.

In the illustrated examples of FIGS. DiA and D1B, computing devices include operating systems. As used herein, an “operating system” is software to control example computing devices, such as the example Edge compute node D100 of FIG. DiA and/or the example Edge compute node D150 of FIG. D1B. Example operating systems include, but are not limited to consumer-based operating systems (e.g., Microsoft® Windows® 10, Google® Android® OS, Apple® Mac® OS, Linux, etc.). Example operating systems also include, but are not limited to industry-focused operating systems, such as real-time operating systems, hypervisors, etc. An example operating system on a first Edge compute node may be the same or different than an example operating system on a second Edge compute node. In some examples, the operating system invokes alternate software to facilitate one or more functions and/or operations that are not native to the operating system, such as particular communication protocols and/or interpreters. In some examples, the operating system instantiates various functionalities that are not native to the operating system. In some examples, operating systems include varying degrees of complexity and/or capabilities. For instance, a first operating system corresponding to a first Edge compute node includes a real-time operating system having particular performance expectations of responsivity to dynamic input conditions, and a second operating system corresponding to a second Edge compute node includes graphical user interface capabilities to facilitate end-user I/O.

### Examples

Illustrative examples of the technologies described throughout this disclosure are provided below. Embodiments of these technologies may include any one or more, and any combination of, the examples described below. In some embodiments, at least one of the systems or components set forth in one or more of the preceding figures may be configured to perform one or more operations, techniques, processes, and/or methods as set forth in the following examples.

Example 1 includes a system, comprising: interface circuitry; and processing circuitry to: receive, via the interface circuitry, performance data indicating a performance of a plurality of wireless networks, wherein the wireless networks are based on a plurality of wireless technologies, and wherein the performance data is based on a plurality of protocol layers of the wireless technologies; determine, based on the performance data, one or more configuration settings to be adjusted for one or more of the wireless networks; and adjust the one or more configuration settings for one or more of the wireless networks.

Example 2 includes the system of Example 1, wherein the performance data comprises: one or more quality of service (QoS) metrics for one or more of the wireless networks; and radio frequency (RF) spectrum data, wherein the RF spectrum data is based on an analysis of RF signals detected at a plurality of frequencies by one or more RF receivers, wherein the one or more RF receivers are independent of the plurality of wireless networks.

Example 3 includes the system of Example 2, wherein the one or more QoS metrics indicate one or more of: demodulation errors; data transmission errors; signal quality; network layer performance; or transport layer performance.

Example 4 includes the system of any of Examples 2-3, wherein the performance data further comprises spatiotemporal performance data, wherein the spatiotemporal performance data indicates a performance of one or more of the wireless networks based on time and location.

Example 5 includes the system of any of Examples 2-4, wherein the processing circuitry to determine, based on the performance data, the one or more configuration settings to be adjusted for one or more of the wireless networks is further to: detect, based on the RF spectrum data, one or more sources of signal interference for one or more of the wireless networks.

Example 6 includes the system of any of Examples 1-5, wherein the processing circuitry to determine, based on the performance data, the one or more configuration settings to be adjusted for one or more of the wireless networks is further to: determine, based on the performance data and one or more traffic flow objectives, the one or more configuration settings to be adjusted for one or more of the wireless networks, wherein the one or more traffic flow objectives indicate a priority among a plurality of traffic flows on the wireless networks.

Example 7 includes the system of any of Examples 1-6, wherein the one or more configuration settings comprise one or more of: a modulation setting; a transmission power setting; an operating channel setting; a radio resource management setting; or a quality of service setting.

Example 8 includes the system of any of Examples 1-7, wherein the protocol layers comprise a physical layer, a network layer, and a transport layer.

Example 9 includes the system of any of Examples 1-8, wherein: the wireless technologies are based on corresponding protocol stacks; and the performance data is based on the protocol layers from multiple levels of the protocol stacks.

Example 10 includes the system of any of Examples 1-9, wherein the one or more configuration settings are determined based on a machine learning (ML) model, wherein the ML model is trained to infer configuration adjustments based on past performance data for the wireless technologies.

Example 11 includes the system of any of Examples 1-10, wherein three or more of the wireless networks are based on three or more of the following wireless technologies: Bluetooth; Wi-Fi; cellular technology; or IEEE 802.15.4 Low-Rate Wireless Personal Area Network technology.

Example 12 includes at least one non-transitory machine-readable storage medium having instructions stored thereon, wherein the instructions, when executed on processing circuitry, cause the processing circuitry to: receive performance data indicating a performance of a plurality of wireless networks deployed in an environment, wherein the wireless networks are based on a plurality of wireless technologies, wherein the wireless technologies are based on corresponding protocol stacks, and wherein the performance data is based on a plurality of protocol layers from different levels of the protocol stacks; determine, based on the performance data, one or more configuration settings to be adjusted for one or more of the wireless networks; and adjust the one or more configuration settings for one or more of the wireless networks.

Example 13 includes the storage medium of Example 12, wherein the performance data comprises one or more quality of service (QoS) metrics for one or more of the wireless networks, wherein the one or more QoS metrics indicate one or more of: demodulation errors; data transmission errors; signal quality; network layer performance; or transport layer performance.

Example 14 includes the storage medium of Example 13, wherein the performance data further comprises spatiotemporal performance data, wherein the spatiotemporal performance data indicates a performance of one or more of the wireless networks based on time and location.

Example 15 includes the storage medium of any of Examples 13-14, wherein the performance data further comprises radio frequency (RF) spectrum data, wherein the RF spectrum data is based on an analysis of RF signals detected at a plurality of frequencies by one or more RF receivers, wherein the one or more RF receivers are independent of the plurality of wireless networks.

Example 16 includes the storage medium of Example 15, wherein the instructions that cause the processing circuitry to determine, based on the performance data, the one or more configuration settings to be adjusted for one or more of the wireless networks further cause the processing circuitry to: detect, based on the RF spectrum data, one or more sources of signal interference for one or more of the wireless networks.

Example 17 includes the storage medium of any of Examples 12-16, wherein the instructions that cause the processing circuitry to determine, based on the performance data, the one or more configuration settings to be adjusted for one or more of the wireless networks further cause the processing circuitry to: determine, based on the performance data and one or more traffic flow objectives, the one or more configuration settings to be adjusted for one or more of the wireless networks, wherein the one or more traffic flow objectives indicate a priority among a plurality of traffic flows on the wireless networks.

Example 18 includes the storage medium of any of Examples 12-17, wherein the one or more configuration settings comprise one or more of: a modulation setting; a transmission power setting; an operating channel setting; a radio resource management setting; or a quality of service setting.

Example 19 includes the storage medium of any of Examples 12-18, wherein the one or more configuration settings are determined based on a machine learning (ML) model, wherein the ML model is trained to infer configuration adjustments based on past performance data for the wireless technologies.

Example 20 includes the storage medium of any of Examples 12-19, wherein the protocol layers comprise a physical layer, a network layer, and a transport layer.

Example 21 includes the storage medium of any of Examples 12-20, wherein three or more of the wireless networks are based on three or more of the following wireless technologies: Bluetooth; Wi-Fi; cellular technology; or IEEE 802.15.4 Low-Rate Wireless Personal Area Network technology.

Example 22 includes a method, comprising: receiving performance data indicating a performance of a plurality of wireless networks deployed in an environment, wherein the wireless networks are based on a plurality of wireless technologies, wherein the wireless technologies are based on corresponding protocol stacks, and wherein the performance data is based on a plurality of protocol layers from different levels of the protocol stacks; determining, based on the performance data, one or more configuration settings to be adjusted for one or more of the wireless networks; and adjusting the one or more configuration settings for one or more of the wireless networks.

Example 23 includes the method of Example 22, wherein the performance data comprises: one or more quality of service metrics for one or more of the wireless networks; and radio frequency (RF) spectrum data, wherein the RF spectrum data is based on an analysis of RF signals detected at a plurality of frequencies by one or more RF receivers, wherein the one or more RF receivers are independent of the plurality of wireless networks.

Example 24 includes the method of any of Examples 22-23, wherein the one or more configuration settings are determined based on a machine learning (ML) model, wherein the ML model is trained to infer configuration adjustments based on past performance data for the wireless technologies.

Example 25 includes the method of any of Examples 22-24, wherein the protocol layers comprise a physical layer, a network layer, and a transport layer.

Example 26 includes the system of Example 5, wherein the one or more sources of signal interference include transmissions from a plurality of devices, wherein the respective devices have physically independent housings.

While the concepts of the present disclosure are susceptible to various modifications and alternative forms, specific embodiments thereof have been shown by way of example in the drawings and are described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one of A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on one or more transitory or non-transitory machine-readable (e.g., computer-readable) storage media, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

1. A system, comprising:
interface circuitry; and
processing circuitry to:
receive, via the interface circuitry, performance data indicating a performance of a plurality of wireless networks, wherein the wireless networks are based on a plurality of wireless technologies having different respective frequency spectrums, and wherein the performance data is based on a plurality of protocol layers of the wireless technologies;
determine, based on the performance data, one or more configuration settings to be adjusted for one or more of the wireless networks; and
adjust the one or more configuration settings for one or more of the wireless networks.

2. The system of claim 1, wherein the performance data comprises:
one or more quality of service (QoS) metrics for one or more of the wireless networks; and
radio frequency (RF) spectrum data, wherein the RF spectrum data is based on an analysis of RF signals detected at a plurality of frequencies by one or more RF receivers, wherein the one or more RF receivers are independent of the plurality of wireless networks.

3. The system of claim 2, wherein the one or more QoS metrics indicate one or more of:
demodulation errors;
data transmission errors;
signal quality;
network layer performance; or
transport layer performance.

4. The system of claim 2, wherein the performance data further comprises spatiotemporal performance data, wherein the spatiotemporal performance data indicates a performance of one or more of the wireless networks based on time and location.

5. The system of claim 2, wherein the processing circuitry to determine, based on the performance data, the one or more configuration settings to be adjusted for one or more of the wireless networks is further to:
detect, based on the RF spectrum data, one or more sources of signal interference for one or more of the wireless networks.

6. The system of claim 5, wherein the one or more sources of signal interference include transmissions from a plurality of devices, wherein the respective devices have physically independent housings.

7. The system of claim 1, wherein the processing circuitry to determine, based on the performance data, the one or more configuration settings to be adjusted for one or more of the wireless networks is further to:
determine, based on the performance data and one or more traffic flow objectives, the one or more configuration settings to be adjusted for one or more of the wireless networks, wherein the one or more traffic flow objectives indicate a priority among a plurality of traffic flows on the wireless networks.

8. The system of claim 1, wherein the one or more configuration settings comprise one or more of:
a modulation setting;
a transmission power setting;
an operating channel setting;
a radio resource management setting; or
a quality of service setting.

9. The system of claim 1, wherein the protocol layers comprise a physical layer, a network layer, and a transport layer.

10. The system of claim 1, wherein:
the wireless technologies are based on corresponding protocol stacks; and
the performance data is based on the protocol layers from multiple levels of the protocol stacks.

11. The system of claim 1, wherein the one or more configuration settings are determined based on a machine learning (ML) model, wherein the ML model is trained to infer configuration adjustments based on past performance data for the wireless technologies.

12. The system of claim 1, wherein three or more of the wireless networks are based on three or more of the following wireless technologies:
Bluetooth;
Wi-Fi;
cellular technology; or
IEEE 802.15.4 Low-Rate Wireless Personal Area Network technology.

13. At least one non-transitory machine-readable storage medium having instructions stored thereon, wherein the instructions, when executed on processing circuitry, cause the processing circuitry to:
receive performance data indicating a performance of a plurality of wireless networks deployed in an environment, wherein the wireless networks are based on a plurality of wireless technologies, wherein the wireless technologies are based on corresponding protocol stacks, and wherein the performance data is based on a plurality of protocol layers from different levels of the protocol stacks;
determine, based on the performance data, one or more configuration settings to be adjusted for one or more of the wireless networks; and
adjust the one or more configuration settings for one or more of the wireless networks.

14. The storage medium of claim 13, wherein the performance data comprises:
one or more quality of service (QoS) metrics for one or more of the wireless networks; and
radio frequency (RF) spectrum data, wherein the RF spectrum data is based on an analysis of RF signals detected at a plurality of frequencies by one or more RF receivers, wherein the one or more RF receivers are independent of the plurality of wireless networks.

15. The storage medium of claim 13, wherein the instructions that cause the processing circuitry to determine, based on the performance data, the one or more configuration settings to be adjusted for one or more of the wireless networks further cause the processing circuitry to:
determine, based on the performance data and one or more traffic flow objectives, the one or more configuration settings to be adjusted for one or more of the wireless networks, wherein the one or more traffic flow objectives indicate a priority among a plurality of traffic flows on the wireless networks.

16. The storage medium of claim 13, wherein the one or more configuration settings comprise one or more of:
a modulation setting;
a transmission power setting;
an operating channel setting;
a radio resource management setting; or
a quality of service setting.

17. The storage medium of claim 13, wherein the one or more configuration settings are determined based on a machine learning (ML) model, wherein the ML model is trained to infer configuration adjustments based on past performance data for the wireless technologies.

18. The storage medium of claim 13, wherein the protocol layers comprise a physical layer, a network layer, and a transport layer.

19. A method, comprising:
receiving performance data indicating a performance of a plurality of wireless networks deployed in an environment, wherein the wireless networks are based on a plurality of wireless technologies, wherein the wireless technologies are based on corresponding protocol stacks, and wherein the performance data is based on a plurality of protocol layers from different levels of the protocol stacks;
determining, based on the performance data, one or more configuration settings to be adjusted for one or more of the wireless networks; and
adjusting the one or more configuration settings for one or more of the wireless networks.

20. The method of claim 19, wherein the performance data comprises:
one or more quality of service metrics for one or more of the wireless networks; and
radio frequency (RF) spectrum data, wherein the RF spectrum data is based on an analysis of RF signals detected at a plurality of frequencies by one or more RF receivers, wherein the one or more RF receivers are independent of the plurality of wireless networks.
